(19) United States
(12) Patent Application Publication
(10) Pub. No.: US 2017/0103412 A1
(43) Pub. Date: Apr. 13, 2017

(54) ONLINE ENTERTAINMENT AND BRAND MATCHING

(71) Applicant: Madison & Sunset (DBA HollyFy), Los Angeles, CA (US)

(72) Inventors: Erik Thomas Norgaard, Los Angeles, CA (US); Aju Thomas, Sherman Oaks, CA (US)

(21) Appl. No.: 15/289,068

(22) Filed: Oct. 7, 2016

Related U.S. Application Data
(60) Provisional application No. 62/239,845, filed on Oct. 9, 2015.

(51) Int. Cl. G06Q 30/02; G06F 17/30; H04L 29/08

(52) U.S. Cl. CPC G06Q 30/0244; H04L 67/306; G06F 17/30867; G06F 3/04817

(57) ABSTRACT

A computer-based system for presenting brand integration, embedded marketing, product placement, sponsorships and other branded entertainment analysis and suggested opportunities is disclosed using a brand integration matching server system, connected to a public network, wherein the brand integration matching server system is configured to: receive a brand integration seeker's data and generate a brand integration seeker's suggested opportunities, receive a brand marketer's data and generate a page, receive an entertainment producer's data and generate a page; and calculate a probability value generated from correlating the brand marketer's page with the entertainment producer's page, such correlation resulting in a potential match if the probability value meets or exceeds a predetermined threshold; in the event of a potential match, present the data associated with the entertainment producer to the brand marketer based on one or more of the probability values, and present the data associated with the brand marketer to the entertainment producer based on one or more of the probability values; and use a user interface device that is configured to enable the brand marketer and the entertainment producer to evaluate the potential match.

### RELATED APPLICATIONS

Applicant claims the benefit of priority of prior, co-pending provisional application Ser. No. 62/239,845, filed Oct. 9, 2015, the entirety of which is incorporated by reference.

### FIELD OF INVENTION

The technology relates to computer-based operation of an entertainment and brand matching service utilizing electronic data related to participants' electronic profiles, e.g., type of entertainment, type of brand, genre, and type of integration.

### BACKGROUND OF THE INVENTION

Surveys have shown that the majority of advertising goes unnoticed. According to research performed by CMO Council (Chief Marketing Officer Council World Wide), 86% of people skip television commercials and a majority of traditional advertising is not seen at all by its target audience. As this is occurring, entertainment production and consumption is increasing as more forms of video, on-demand, music, social media, video games and other entertainment is becoming widely available. Another research study from the firm PQ media illustrates the shift in consumer sentiment, showing that the growth in branded entertainment and specifically product placement has increased by 13.6% in 2014. One possible cause for this shift is a failure in the advertising and marketing process, which may bring significant consequences for both the brand advertisers and entertainment producers. Poor selection of where to find suitable brand integration partners may lead to financial loss for both brand marketers and entertainment producers. Limited selection by entertainment producers of which brands are interested may reduce funding, reduce jobs and lower productivity. Overall, poor selection can be characterized as a mismatch between brand integration seekers; both brand advertisers and entertainment producers. Such mismatches arise from both sides lacking a more complete picture and control of the brand integration seeking and selection process. Matching the right brand to the right entertainment production, or entity, can be a complex process. The success of this matching depends on a large number of variables, including, but not limited to, the brand integration seeker's goals, objectives, price vs. budget, integration offerings, target audience/market, type of product or service brand, and the entertainment producer's needs. A brand marketer often has little information about an entertainment producer except what the seeker can find on the Internet or hire an independent firm to tap into their limited resources. The entertainment producer typically has to rely on the brand marketer's outreach, which may poorly impact the marketer's negotiating ability or perform their own outreach, which may limit the entertainment production's position. As a result, many potentially good branded entertainment opportunities may not reach the review process.

Accordingly, online entertainment and brand matching systems and methods that utilize more complete details about the brand, entertainment production and brand integration listings would be desirable.

### SUMMARY OF THE DESCRIPTION

A method and apparatus of a system that determines brand integration analysis matches is described. In an exemplary embodiment, the system includes an entertainment and brand matching server system and at least one user interface device each coupled to a public network. The server system is configured to receive and store a brand advertiser or entertainment productions data in memory. The server system is further configured to generate a showcase page and integration listings, receive and store data about brand advertiser or entertainment production, and generate team profiles for specific users. In addition, the server system is configured to generate listings for brand advertisers or entertainment productions; calculate a plurality of matching probability values by correlating the brand advertiser interest with the specific entertainment production's opportunities; use the plurality of matching probability values to create matches between integration listings and correlated users if an overall matching probability value meets or exceeds a predetermined threshold. Furthermore, the server system is configured to calculate a generalized matching probability value by correlating the brand advertiser content with the data of generalized types of entertainment productions, such correlation resulting in a potential match if the matching probability value meets or exceeds a predetermined threshold. In addition, the server system is configured to use calculated matching probability values generated from correlation of brand advertiser content with the content of generalized types of entertainment productions to create matches between integration listings and correlated users if the compatibility value meets or exceeds a predetermined threshold. The server system is further configured to present data associated with the specific entertainment production's showcase page or listing to the brand advertiser based on one or more of the matching probability values when a brand advertiser search result or match is generated. In addition, the server system is configured to presenting the data associated with the generalized entertainment and production's showcase page or listing to the brand advertiser based on one or more of the matching probability values, when an entertainment production search result or match is generated. The user interface device is configured to enable a user to evaluate the matching probability in a search result or match.

In a further embodiment, a method for determining brand integration analysis matches. In one embodiment, the method receives and stores a brand advertiser or entertainment productions data in memory. The method further generates a showcase page and integration listings, receives and stores data about brand advertiser or entertainment production, and generates team profiles for specific users. The method additionally generates listings for brand advertisers or entertainment productions. In addition, the method calculates a plurality of matching probability values by correlating the brand advertiser content with the specific entertainment production's content. Furthermore, the method uses the plurality of matching probability values to create matches between integration listings and correlated users if an overall matching probability value meets or exceeds a predetermined threshold. In addition, the method calculates a generalized matching probability value by correlating the brand advertiser content with the data of generalized types of entertainment productions, such correlation resulting in a potential match if the matching probability value meets or exceeds a predetermined threshold. The method further uses calculated matching probability values generated from correlation of brand advertiser content with the content of generalized types of entertainment productions to create matches between integration listings and correlated users if the compatibility value meets or exceeds a predetermined threshold. In addition, the method presents data associated with the specific entertainment production's showcase page or listing to the brand advertiser based on one or more of the matching probability values, when a brand advertiser search result or match is generated. The method additionally presents the data associated with the generalized entertainment and production's showcase page or listing to the brand advertiser based on one or more of the matching probability values, when an entertainment production search result or match is generated.

In another embodiment, a non-transitory machine-readable medium containing executable program instructions which when executed by a data processing device cause the device to perform a method to determine brand integration analysis matches. In one embodiment, the method receives and stores a brand advertiser or entertainment productions data in memory. The method further generates a showcase page and integration listings, receives and stores data about brand advertiser or entertainment production, and generates team profiles for specific users. The method additionally generates listings for brand advertisers or entertainment productions. In addition, the method calculates a plurality of matching probability values by correlating the brand advertiser content with the specific entertainment production's content. Furthermore, the method uses the plurality of matching probability values to create matches between integration listings and correlated users if an overall matching probability value meets or exceeds a predetermined threshold. In addition, the method calculates a generalized matching probability value by correlating the brand advertiser content with the data of generalized types of entertainment productions, such correlation resulting in a potential match if the matching probability value meets or exceeds a predetermined threshold. The method further uses calculated matching probability values generated from correlation of brand advertiser content with the content of generalized types of entertainment productions to create matches between integration listings and correlated users if the compatibility value meets or exceeds a predetermined threshold. In addition, the method presents data associated with the specific entertainment production's showcase page or listing to the brand advertiser based on one or more of the matching probability values, when a brand advertiser search result or match is generated. The method additionally presents the data associated with the generalized entertainment and production's showcase page or listing to the brand advertiser based on one or more of the matching probability values, when an entertainment production search result or match is generated.

### BRIEF DESCRIPTION OF THE DRAWINGS

Illustrated in the accompanying drawing(s) is at least one of the preferred embodiments of the present invention:

FIG. 1 is a diagram showing connectivity of parts of an online entertainment and brand matching system according to an embodiment of the present invention.

FIG. 2 is a diagram showing a server as used in an entertainment and brand matching system according to an embodiment of the present invention.

FIG. 3 is a diagram showing user devices according to an embodiment of the present invention;

FIG. 4 is a diagram showing facilitation of communication between brand advertisers, entertainment productions and an online entertainment and brand matching system according to an embodiment of the present invention.

FIG. 5 is a diagram showing parts of a system according to an embodiment of the present invention.

FIG. 6 is a diagram showing contributions to a scoring function according to an embodiment of the present invention.

FIG. 7 shows an example of an entertainment production showcase page as it may be shown in a brand advertiser interface according to an embodiment of the present invention.

FIG. 8 shows an example of a brand advertiser showcase page as it may be shown in an entertainment production interface according to an embodiment of the present invention.

FIG. 9 is a diagram showing an example of a generalized dynamic probability indicator according to an embodiment of the present invention.

FIG. 10 is a diagram showing an example of a specific dynamic probability indicator for brand integration according to an embodiment of the present invention.

FIG. 11 shows an example login screen to a brand matching system according to an embodiment of the present invention.

FIG. 12 is a diagram showing a brand advertiser flow map according to an embodiment of the present invention.

FIG. 13 is a diagram showing an entertainment production flow map according to an embodiment of the present invention.

FIG. 14 is a diagram showing a brand advertiser experience map according to an embodiment of the present invention.

FIG. 15 is a diagram showing an entertainment production experience map according to an embodiment of the present invention.

FIG. 16 is a schematic showing dependencies between various parts of a system according to an embodiment of the present invention.

FIG. 17 is a diagram showing automatic generation of suggested opportunities (a predictive model search flow) for a brand advertiser according to an embodiment of the present invention.

FIG. 18 is a diagram showing automatic generation of suggested opportunities (a predictive model search flow) for an entertainment producer according to an embodiment of the present invention.

FIG. 19 is a diagram showing a ranking search flow for users according to an embodiment of the present invention.

FIG. 20 is a diagram showing a customer ranking model according to an embodiment of the present invention.

FIG. 21 is a diagram showing an email registration flow for a brand advertiser or an entertainment producer according to an embodiment of the present invention.

FIG. 22 is a diagram showing a showcase page builder flow for a brand advertiser according to an embodiment of the present invention.

FIG. 23 is a diagram showing a showcase page builder flow for an entertainment producer according to an embodiment of the present invention.

FIG. 24 is a diagram showing a representative/agent or manager adding process for a brand advertiser or entertainment producer according to an embodiment of the present invention.

FIG. 25 shows an exemplary user homepage according to an embodiment of the present invention.

FIG. 26-A shows an exemplary user registration page according to an embodiment of the present invention.

FIG. 26-B shows an exemplary secondary user registration page according to an embodiment of the present invention.

FIG. 27 shows an exemplary user registration page using a third party system such as a social media site according to an embodiment of the present invention.

FIG. 28 shows a user image upload page according to an embodiment of the present invention.

FIG. 29 shows an exemplary user image upload and editing page according to an embodiment of the present invention.

FIG. 30 is a diagram showing an entertainment production script upload process according to an embodiment of the present invention.

FIG. 31 shows an exemplary entertainment production script analyzer prompt page according to an embodiment of the present invention.

FIG. 32 shows an exemplary entertainment production script recommendations page according to an embodiment of the present invention.

FIG. 33 shows an exemplary entertainment production integration listing review page according to an embodiment of the present invention.

FIG. 34 shows an exemplary entertainment production suggested matches page according to an embodiment of the present invention.

FIG. 35 shows an exemplary brand advertiser/entertainment producer compatibility scorecard prompt page according to an embodiment of the present invention.

FIG. 36 shows an exemplary brand advertiser/entertainment producer compatibility scorecard according to an embodiment of the present invention.

FIG. 37 illustrates one example of a typical computer system, which may be used in conjunction with the embodiments described herein.

FIG. 38 shows an example of a data processing system, which may be used with one embodiment of the present invention.

### DETAILED DESCRIPTION

The above described drawing figures illustrate the invention in at least one preferred embodiment, which is further described in the following description. Those of skill in the art may be able to make alterations and modifications to what is described herein without departing from its spirit and scope. Therefore, it should be understood that what is illustrated is set forth only for the purposes of example and should not be taken as a limitation on the scope of the present system and its method of use.

The description herein and accompanying figures refers at various points to an exemplary embodiment of the invention, which has been implemented as an application program called Hollyfy.

The description herein refers to an entity, the entertainment producer, as an entity or individual that interacts with the computer application. It is not intended that this term be limited to a producer, but many encompass any one or more other individuals having a role in an entertainment production, such as a show runner, screenwriter, director, musician, game developer, etc. Such individuals may also consider themselves to be part of a larger whole, referred to as an “entertainment production”, and this entity also could be represented in its interactions with brand advertisers via the computer application described herein.

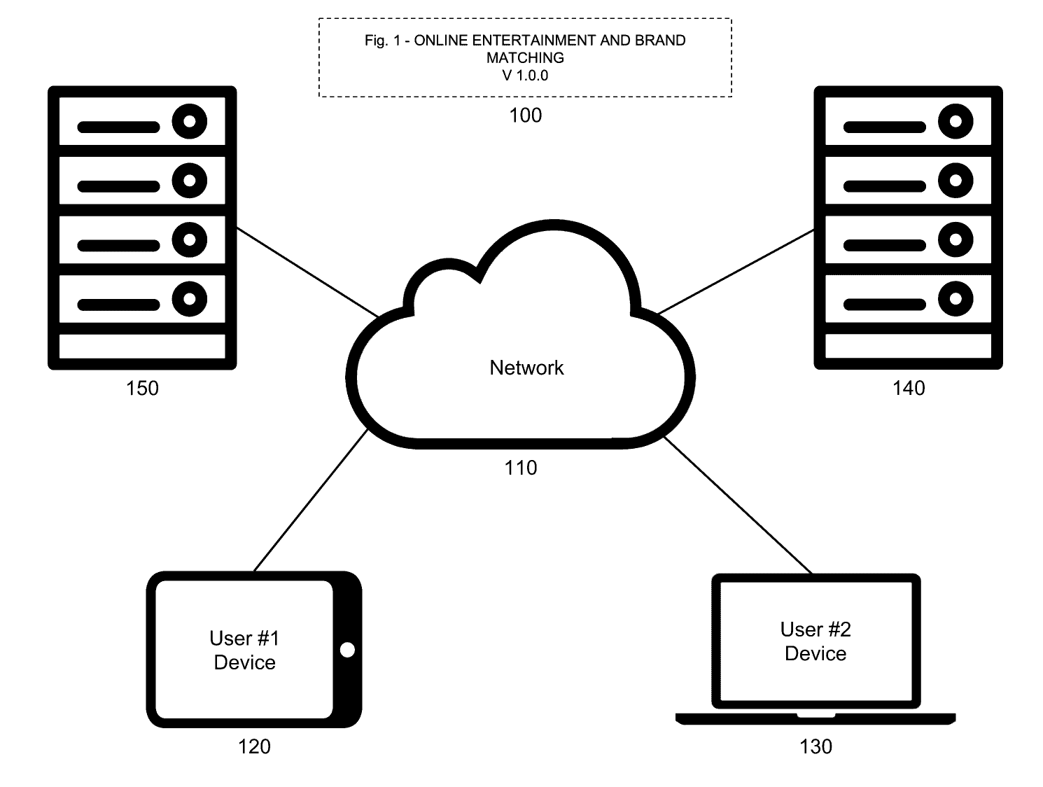

FIG. 1 shows a computer-based entertainment and brand matching system 100 according to an embodiment of the present invention. The system generally includes an entertainment and brand matching server system 140, which may be distributed on one or more physical servers, each having one or more processors, memory, an operating system, and input/output interface, and one or more network interfaces all known in the art, a plurality of end user devices 120, 130, and/or one or more third-party server systems 150, all of which may be connected to a public network 110, such as the Internet and/or a cellular-based wireless network.

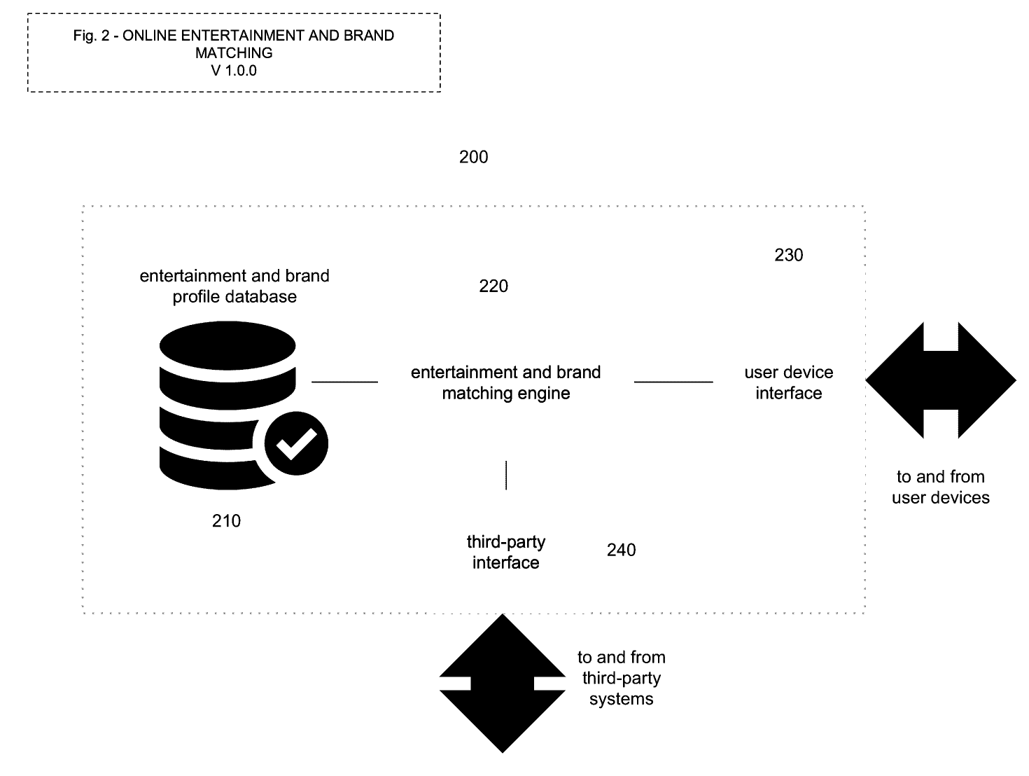

An example embodiment of the entertainment and brand matching server system 200 is shown in FIG. 2. The entertainment and brand matching server system 200 generally includes a computer-implemented entertainment and brand matching engine 220 designed to match end users who are brand integration seekers (also referred to herein as advertisers) with opportunities at which the potential to have a successful brand integration is optimized, and/or entertainment producers who are also users of the matching server system 200, with similarly optimized brand advertisers. To obtain potential matches, each brand advertiser is represented by a plurality of normalized descriptors, such as on a “brand showcase page”, and each entertainment producer is represented by a plurality of normalized descriptors such as on an “entertainment showcase page.”

As used herein, the term user can mean any of brand advertiser(s) or entertainment producer(s), or those entities collectively.

A brand showcase page includes data and factors which have been empirically shown to be relevant to finding and establishing successful brand integration. These data and factors include, but are not limited to, type of product/service, target audience/market, budget, integration interests, type of integration, schedule, marketing preferences, marketing factors, and so on.

Data for the brand showcase page can be collected via online on-boarding data fields completed by representative(s) in order to describe their brand. Data for the entertainment showcase page includes data aggregated from previous productions, online on-boarding data fields and questionnaires completed by representative(s) in order to describe their entertainment production, and third party data purchased from industry tracking services such as Nielsen's, IMDB, PQ Media, or other data services.

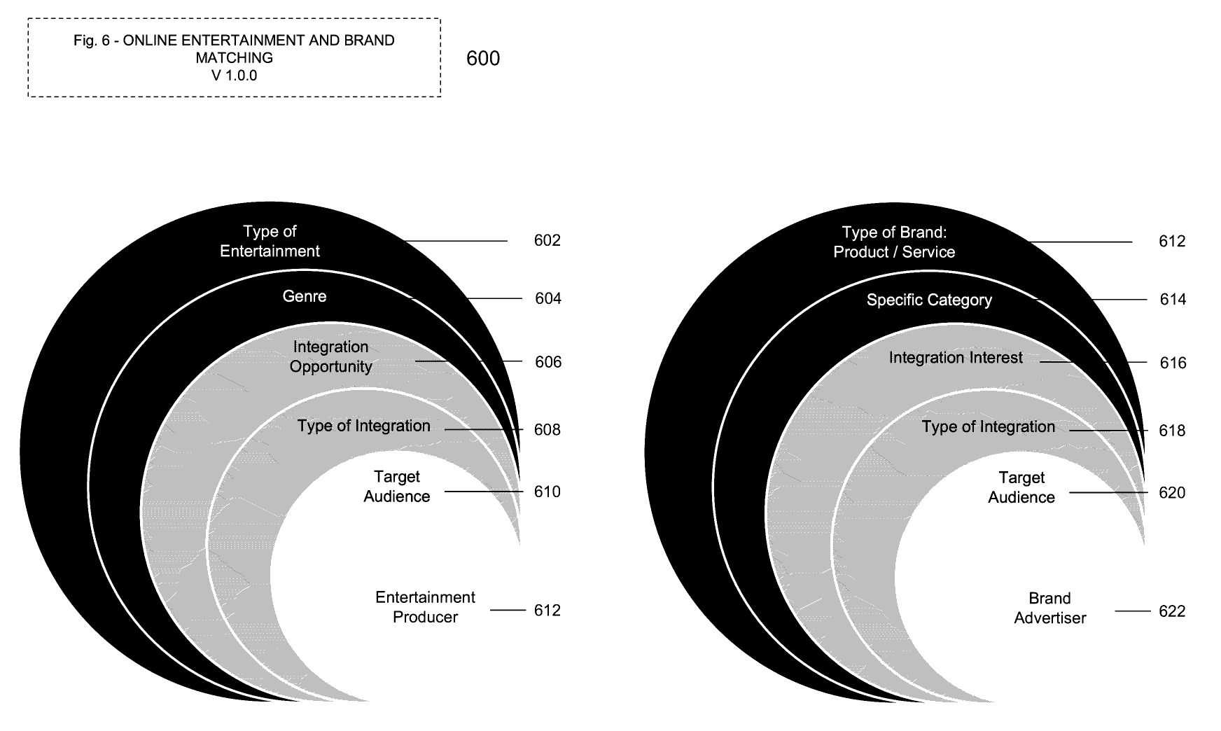

The brand advertiser and entertainment production profiles, showcase pages, listings (integration interests and integration opportunities) associated with each user are stored in entertainment and brand profile database 210, which may comprise one or more logical or physical databases. The profiles, pages and integration listings are organized by the user's (brand advertiser or entertainment producer) profile/page identification (“ID”). In the process of creating potential brand integration matches for a particular brand integration seeker, an entertainment and brand matching engine 220 queries the brand integration seeker's data by its respective ID, and correlates that page/profile with entertainment producer pages or brand advertiser pages as linked to specific listings to calculate a probability, or predictive score. In some embodiments, if a brand advertiser page and one or more entertainment producer pages generate a probability value, or predictive success score, that meets or exceeds a predefined threshold, then there is potential for the respective brand integration seeker and one or more entertainment producers or brand advertisers to have a satisfactory and/or successful brand integration partnership if matched. In one embodiment, the probability value is computed for the scoring as described in FIG. 6 below. This calculation can also incorporate data based on a user's previous history of data, thereby enabling a feedback system that allows the system 200 to “learn” how to optimize the scoring calculation. This process can also involve developing and utilizing a “neural network” to resolve problems in complex data.

In some embodiments, thresholds need not be used in order to predict satisfactory and/or successful brand integration partnerships. For example, users (brand advertiser or entertainment production) will be able to search for each other and see results that show all levels of probability rather than a selection or subset thereof. In many of these embodiments, only automatic matching conducted by the system will require using a threshold (a minimum probability score).

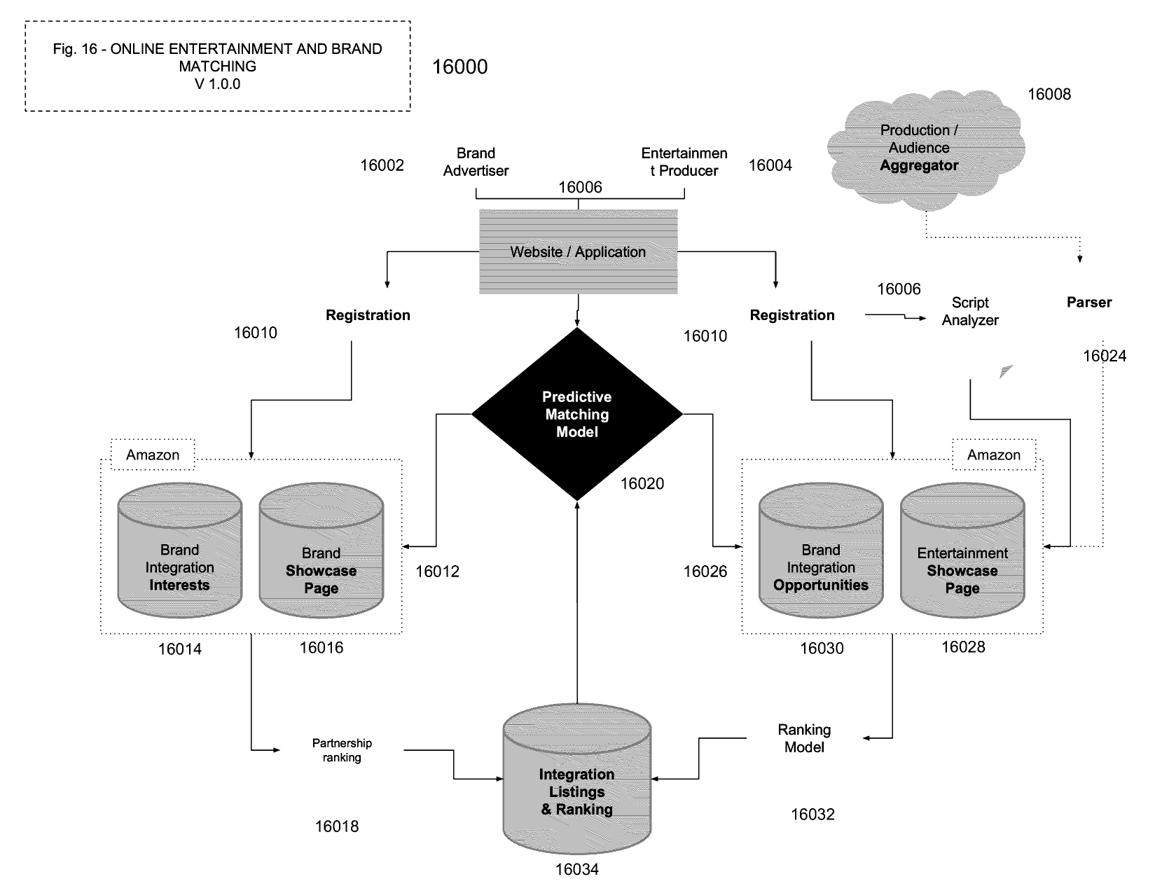

According to an embodiment, the entertainment and brand matching engine 220 may also interface with other third-party online databases or other matching systems 16008 (see FIG. 16), e.g., IMDB, Neilsen, YouTube, Google, LinkedIn, Facebook, Twitter. Such interfaces may be used to post and/or retrieve integration listings, company profiles, representative profiles, and so on.

In an embodiment, the entertainment and brand matching engine 220 is configured to generate more than one probability value, or predictive score, between two or more correlated profiles, where each probability value, or predictive score, is associated with a different set of factors and/or a different weighing of factors.

In another embodiment, the system 200 further provides a script analysis application 16006 (see FIG. 16) for the entertainment producers. The system 200 may also provide the entertainment and brand matching service on a free, trial or subscription based model. The subscription fee may have one or more tiers, each tier offering a different level of service. Some of these models are described in conjunction with other FIGS. below.

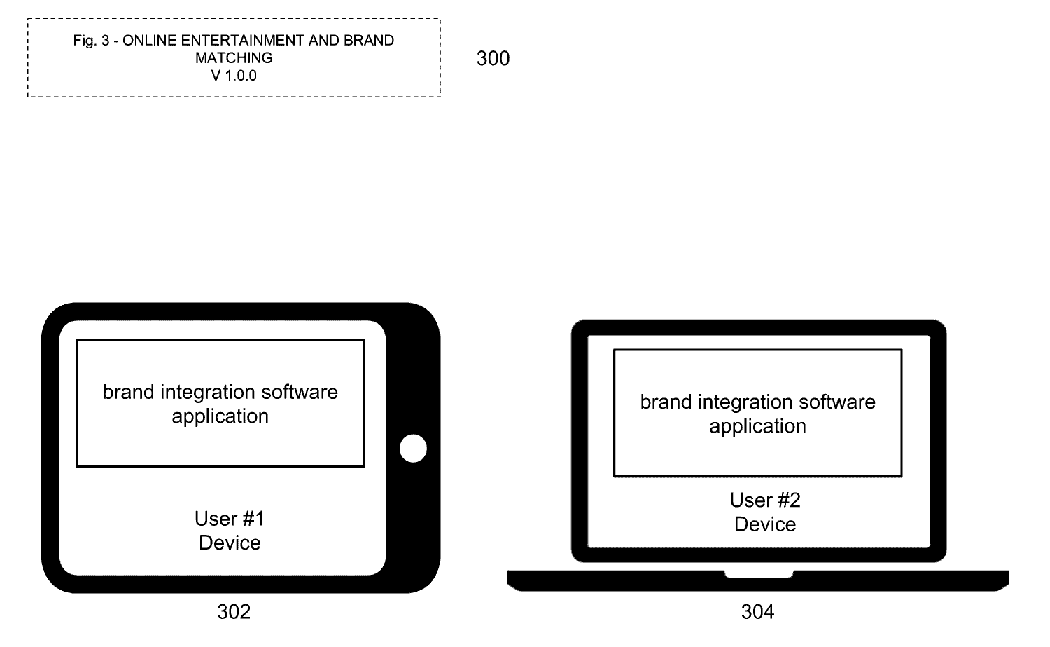

In another embodiment, the system 200 includes a brand integration software application that may be pushed to, or downloaded to, and installed on user devices 302, 304, as shown in FIG. 3.

Features in the embodiments described above include:
Matching engine that calculates measurements of interests and opportunities being collected on users, measurements of audience/market alignment and values being collected on users, and executes the methods of calculating comparison between these used to generate predicted probability/satisfaction/activation scores (where “activation” refers to a successful brand integration activation between matches).
Electronic system that describes companies based on data collected from surveys administered on the Internet.
Electronic system that generalizes descriptions of specific companies or showcase pages to taxonomies or “company types” (i.e., company industry sectors X audience size X pricing).
Electronic system that generalizes probability scores from specific companies to probability with Company Type profiles.
Electronic system that uses the product of user descriptions and showcase page descriptions as the primary input features in models of predicted probability/satisfaction/engagement.
Electronic system that uses the absolute difference multiplied by the sum of brand advertiser and entertainment producer scores on matched user values and brand integration factors as a primary input feature into empirically validated statistical models of predicted probability/satisfaction/activation.
Electronic system that uses the absolute difference multiplied by the sum of brand integration seeker and pricing/budget scores on matched integration listing factors as a primary input feature into empirically validated statistical models of predicted probability/satisfaction/activation.

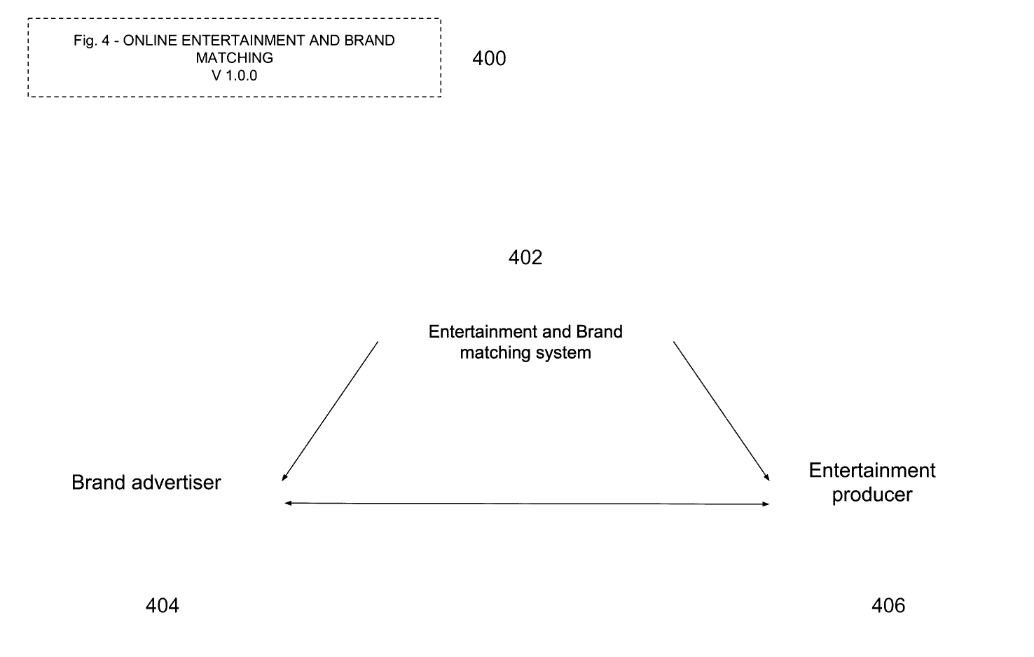

FIG. 4 shows an example embodiment of a system 400 for facilitating between brand advertisers 404, entertainment productions 406, and an online entertainment and brand matching system 402, according to an embodiment of the present invention. In the example embodiment, entertainment producers 406 typically will interact with an interface of the online entertainment and brand matching system 402 in order to establish a brand integration search. In many embodiments, numerous entertainment producers may be passive users of the system, in that they will be profiled based on empirical data gathered from representatives, and/or will be associated with a company type profile, and this information will be used to generate probability scores for brand advertisers in order to evaluate opportunities for potential brand integration. Company type profiles may describe companies in similar fields, of similar size, and in similar locations in order to generalize information for companies for which direct information may not be known. Previously, subsequently or contemporaneously, brand advertisers 404 (also referred to herein as brand integration seekers) will typically interact with an interface of the online entertainment and brand matching system 402 in order to establish a brand integration search. Brand advertisers 404 may also create profiles, showcase pages, integration listings, may register for the system, search member postings, and engage in other actions while searching for brand integration using the online entertainment and brand matching system 402. Online entertainment and brand matching system 402 will generally facilitate interaction and communication between brand advertisers 404 and entertainment productions 406 through the site including using digital images, textual communications, statistical models, video interactions and other communication tools. After initial interaction through online entertainment and brand matching system 402, brand advertisers 404 and entertainment producers 406 may interact outside the online entertainment and brand matching system 402, such as by communicating in person and completing a brand integration process.

Automatic matching of brand advertisers to integration opportunities using an online entertainment and brand matching system 402 is performed by the system and is based on probability. In various embodiments the system may send e-mail and push notifications to facilitate consideration and communication between brand advertisers and entertainment producers.

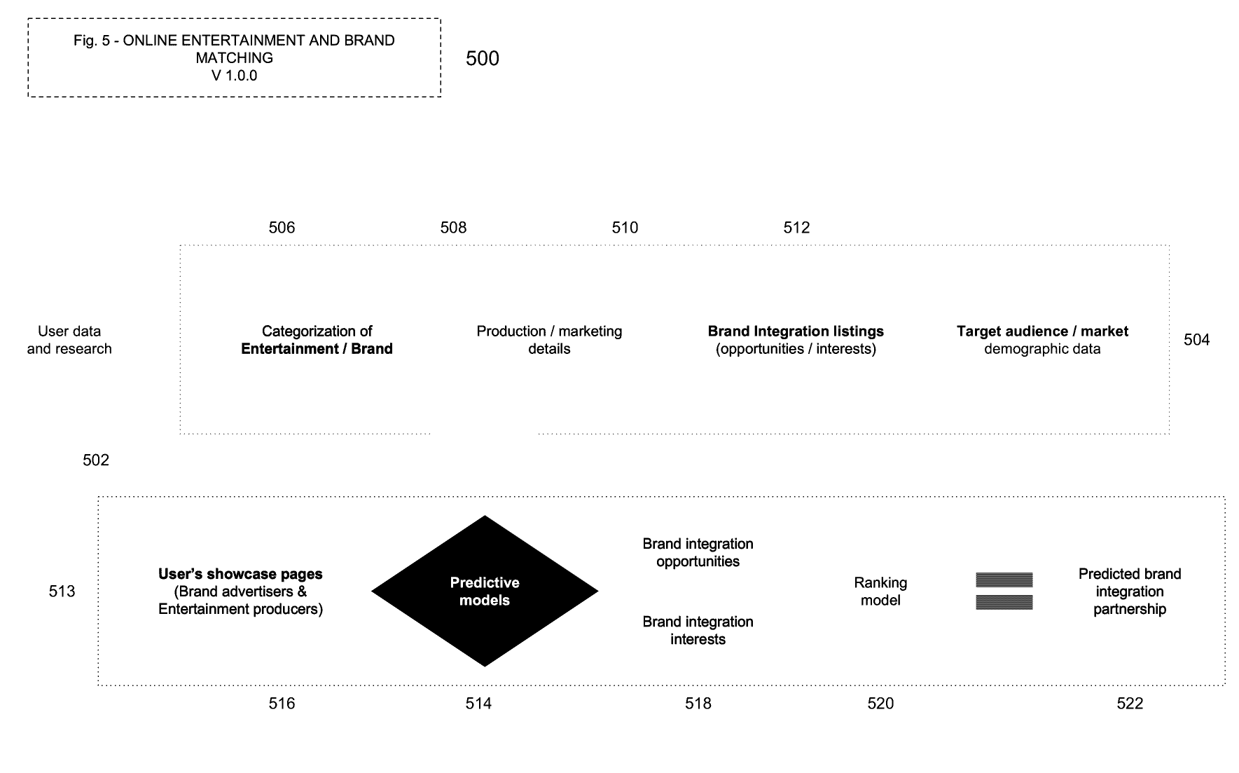

FIG. 5 shows an example embodiment of system blocks 500 in accordance with the present invention. In the example embodiment user data and research 502 is included and utilized in developing profile and showcase page information for both entertainment productions and brand advertisers and predictive algorithms 514. Entertainment producer and brand advertiser page information 504 may be a composite of one or more categorization of entertainment/brand 506, one or more production / marketing details 508, one or more brand integration listings (opportunities / interests) 510, one or more target audience/market demographics 512, images and other profile information. Users' showcase page information 516 may include self-identified information supplied by users in on-boarding sessions, questionnaires, descriptions, integration opportunities/interests (listings), target audience, and other profile information.

In one embodiment, a brand integration listing is a listing that describes a type of integration opportunity a brand advertiser is interested in. In this embodiment, a brand integration listing can include information for one or more factors, such as opportunity/interest factors (e.g., entertainment type, target date, genre, and/or other types of opportunity/interest factors), target audience/market factors (e.g., demographics, target market, and/or other types of target audience/market factors), and/or pricing/budget factors (e.g., brand advertiser budget and/or other types of pricing/budget factors). Each of these factors can be further sub-divided into other factors. For example and in one embodiment, the entertainment type factor can be further sub-divided into sub-factors, such as type of entertainment can be on-screen integration or off-screen integration, storyline integration, type of presentation (e.g., visual, audio, or both), who uses the brand (principal, secondary, narrator, and/or another person), where (foreground/background), type of performance (e.g., concert, event, appearance, and/or another type of performance), and/or other type of sub-factors. In one embodiment, the brand integration listing is defined using a brand integration taxonomy.

In another embodiment, an entertainment opportunity listing is a listing that describes a type of entertainment opportunity an entertainment producer is offering. In one embodiment, a entertainment opportunity can include information for one or more factors, such as opportunity/interest factors (e.g., brand/product/service type, integration type, category, target date, and/or other types of opportunity/interest factors), target audience/market factors (e.g., demographics, target market, and/or other types of target audience/market factors), and/or pricing/budget factors (e.g., price and/or other types of pricing/budget factors). Each of these factors can be further sub-divided into other factors. For example and in one embodiment, brand/service type can be further into sub-factors. In this example, the brand/service can be described using primary, secondary, and tertiary factors. A primary factor can be a broad type of brand/service (e.g., apparel, body care, software, etc.), a secondary factor a further refinement of the primary (e.g., women's clothing, shampoo, video games, etc.), and a tertiary factor is a further refinement of the secondary (denim, dandruff shampoo, smartphone games, etc.). In addition, the genre of the entertainment offering can further be divided into primary factors (e.g., television, movies, music, video games, social media, virtual reality, live events, virtual media, etc.), where each of the primary factors can be further subdivided into different factors such as a genre (e.g., television (e.g., action, adventure, drama, comedy, family, etc.), movies (e.g., action, adventure, drama, comedy, family, etc.), music (e.g., pop, hip-hop, country, jazz, classical, etc.), video games (e.g., shooter, role-playing, etc.), social media (e.g. Twitter, YouTube, SanpChat, Instagram, Facebook, LinkedIn, etc.), and/or virtual reality (e.g., video games, movies, augmented reality, etc.)). In one embodiment, the brand integration listing is defined using a brand integration taxonomy.

In one embodiment, by classifying each of the brand integration and entertainment offering listing into the brand integration and entertainment offering listings, respectively, the system can compare pairs of brand integration and entertainment offering listings to determine matches for these listings. In one embodiment, a scoring function is used to determine better or worse brand integration and entertainment offering listing matches.

The system uses predictive models 514 in order to analyze user showcase pages 516 and listings (opportunities/interests) 518, and sorts content utilizing a ranking model 520 in predicting successful brand integration partners 522.

An example embodiment of a conceptual predictive model includes opportunity/interest factors A-F, target audience/market factors G-K and pricing/budget factors L-P used in a formula such as f[(Au)(G(U−u))bi+. . . +(Ki)(P(U−u))bi where dependent measure for training weights b(i−k)=brand integration probability. In the example embodiment some main effects may be partialed out and/or controlled. (Certain control factors may be parsed into the matching algorithm as the system adapts and learns more about the user's needs and wants. Depending on membership, user search query, and data fields within the website/application, specific information may be extracted and displayed to accommodate specific user experience and best practices.)

Examples of integration alignment identified in users' data and categorization of entertainment/brand 506 may include: type of product/service, sub-categorization of brand, type of entertainment, media type, genre, sub-genre and more. Examples of production and marketing details 508 may include: release/target date, schedule, rating, cast/crew, and others. Examples of brand integration listings (opportunities/interests) details 510 may include: type of integration, price/budget, integration deadline, context, screen-time, and others. Examples of target audience/market demographic data details 512 may include: target audience size, gender, age, household composition, household income, and others.

Examples of details used in ranking model 520 may include account activeness, offerings score, page view score, shortlist score, connections score, newness score, spam and reports score, and others. In one embodiment, the ranking model uses results of a scoring function that scores pairs of brand integration and entertainment offering listings as described in FIG. 6 below.

FIG. 6 shows an example embodiment of a scoring function 600 in accordance with the present invention. In the example embodiment, profiles may be generated utilizing escalating levels of generalization. This may allow the system to generate probability scores between brand advertisers and entertainment productions. Relative values of general probability scores may be estimated in part on consistency of scores within a level of generalization. In some embodiments this means calculating a standard deviation of any and/or all average scores and using a resulting confidence interval for an estimate of probability. In the example embodiment, levels of scoring are represented as circles of increasing size. A first, smallest, circle is a unique entertainment production level of generalization 612 or brand advertiser level of generalization 622. A next, higher level of generalization is a target audience 610, 620 which may represent the viewers of a producer or purchasers of a brand, i.e., audience/market size, age, gender, household income, household composition, and/or others. A next, higher level of generalization is a type of integration 608, 618 which may be based on one or more metrics such as visual integration, audio integration, audio and visual integration, storyline integration, and/or others. A next, higher level of generalization is integration opportunity 606 regarding listings by entertainment productions which may include a need for certain products, types of locations, service focused brands, pricing and/or others. A similar next, higher level of generalization as it applies to listings by brand advertiser is integration interest 616 which may include a desire for integration in certain forms of entertainment, allotted budget, screen time, context and/or others. A next, higher level of generalization is a genre 604 as it applies to entertainment productions which may include a particular genre or genre subset. Examples of different genres and sub-genre levels include: action-adventure, comedy, racing, pop music, documentary, reality show, electronic music, fashion, role-playing games. A similar next, higher level of generalization is a specific category of brand 614 which may include a particular category or category subset. Examples of different categories and sub-categories include alcoholic, vodka, etc. A next, higher level of generalization is a type of entertainment abstraction 602 as it applies to entertainment productions which may include a particular type of entertainment. Examples of different types of entertainment include: movies, television, music, video games, social media. A similar next, higher level of generalization is a type of brand 612 which may include a particular type of entertainment. Examples of different types of brands and sub-types include: product, beverage.

In one embodiment, the scoring function operates on pairs of brand integration and entertainment offering listings. A closer match between the brand integration and the entertainment offering listings, a higher score results from the scoring function. Conversely, a further match between a brand integration and entertainment offering listing, the smaller score results from the scoring function. In one embodiment, a closer match is one that that matches values from smaller circles. In this embodiment, matches between tertiary or secondary factors of pairs of listings would results in higher scoring function scores.

For example and in one embodiment, consider a brand that is a dandruff shampoo (body care product) that wishes to be integrated into a family movie that is placed on a table by a lead actor/actress for the US market with a budget of $100,000. The brand type would have a primary factor of body care, secondary factor of shampoo, tertiary factor of dandruff shampoo. The entertainment primary factor would be movies, secondary is a family movie. A higher scoring match would be an entertainment offering having a match is all or almost all of these factors. Thus, an entertainment offering of a shampoo in a movie by a lead actor for the US market with a price of $80,000 would be a relatively high score from the scoring function of these two listings. The scoring function may give a lower score to an entertainment offering of a supporting actress speaking about a body care product in a family television show in the US market for a price of $30,000. Thus, the more specific a match between a brand integration and entertainment offering listing gives a higher score from the scoring function.

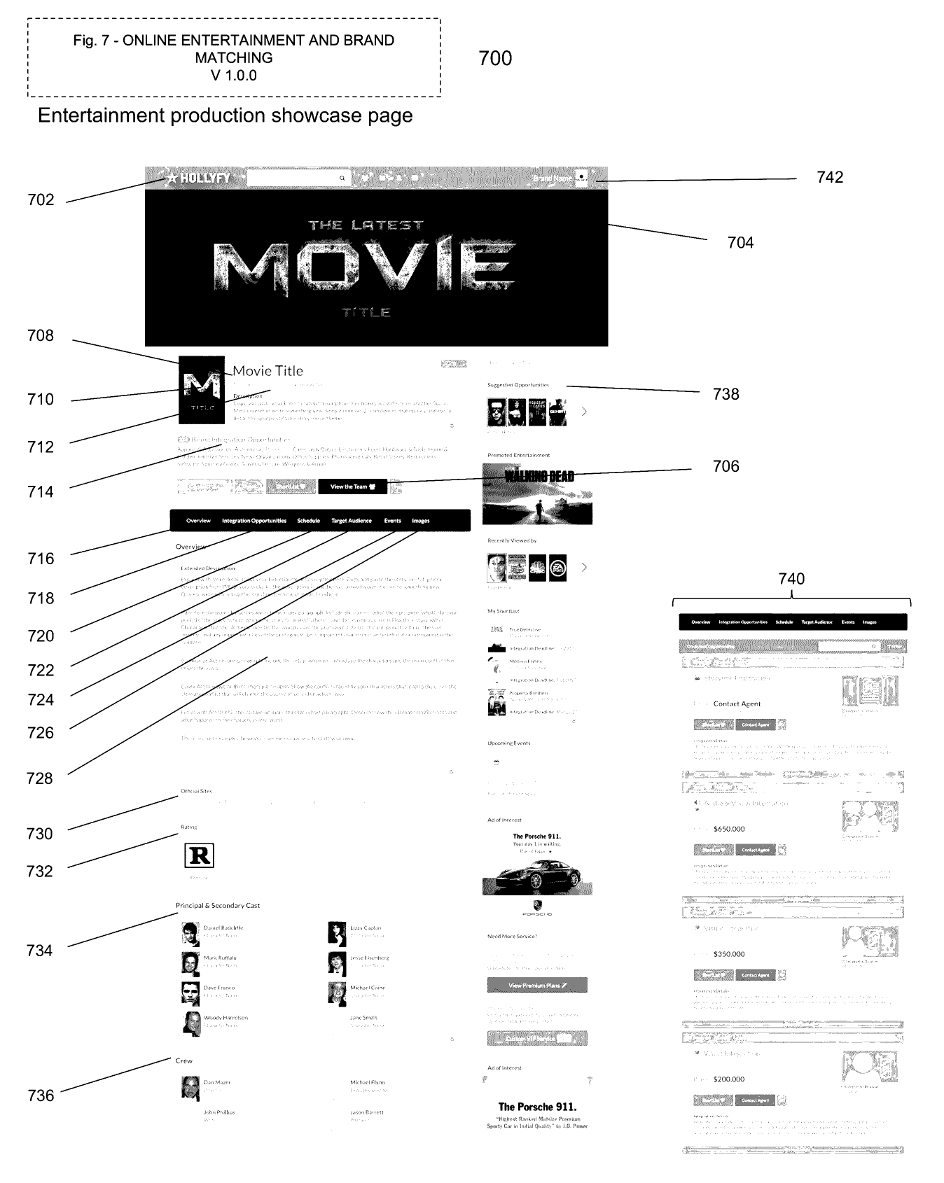

FIG. 7 shows an example embodiment of an entertainment production showcase page 700 as it may be shown in a brand advertiser interface in accordance with the present invention. In the example embodiment, a title and/or homepage button 702 is shown.

Although in the example embodiment it is located in the top-left of the interface the title and/or homepage button 702 will generally be located in the top of the interface but, as with many other buttons and fields that will be described below, could be located elsewhere as appropriate. Informational navigation buttons 704 may include a “Search brand integration” field, a “Connections” button, a “Messages” button, a “Notifications” button, a “Listings” button, an active account identifier button 742 (“Hello, Brand Name” in the example embodiment), a “Dashboard” button, and others. An account management selector within the account identifier button may include tools for a user to post “Integration Listings”, review “Upcoming Integrations”, adjust “Privacy Settings”, adjust “Account Settings”, manage “Connections” and others.

Entertainment production showcase page 700 may include a name/title field 708 (e.g., “Movie title”) and a thumbnail image, photograph, or avatar location 710. In some embodiments, selecting this location may allow scrolling, viewing, or selecting additional images. Identifying information 712 may include information such as the type of entertainment (e.g.,: “Movie/Action-Adventure” in the example embodiment), release date (“August 2018”), short description (“America's favorite movie”). Brand integration listings 714 (“Total”, and types of listings relevant to the user, “Beverage” in the example embodiment) show the current amount of brand integration opportunities and highlight the category relevant to the current user's interface. Also included may be different types of interactive buttons. In the example embodiment, these buttons include “Connect”, “Share”, “ShortList” the entire page to view later, “View the Team” profile, and other buttons. These interface tools may differ depending on membership, account validation and privacy settings.

The system may display numerous informative sections on an entertainment production page 700 which describe aspects of the entertainment. In the example embodiment, an “Overview” section 716, “Integration Opportunities” section 718, “Schedule” section 720, “Target Audience” section 722, “Events” section 724, and “Images” section 726 are shown. An “Overview” section 716 may include 728 an “Extended Description” field, an “Official Sites” list 730 (e.g., Facebook, Instagram, website and others), a “Rating” field 732 (e.g., PG), and “Principal & Secondary Cast” list 734, and a “Crew” list 736 with names, titles, images and third party links.

In addition to the “Overview” section 716, the “Integration Opportunities” section 718 may show lists 740 of potential brand integrations with the entertainment production. A “Most Relevant” list (e.g., beverage/alcoholic/rum) displays and sorts the listings according to values the user may find most relevant for their needs (e.g., listing similarities which align with brand advertiser's listings; or, type of brand required by entertainment production is similar to brand advertiser user; or, release date aligns with target date: or similar target audience/market demographics and others) these listings may be displayed in multiple locations. Graphical icons may be displayed in varying sizes relating to aspects of these listings and various colors may be used to highlight positive and negative attributes.

A “Suggested Opportunities” section 738 may be displayed in various locations and graphical iterations on the website, which offers potential matches and may include images, information and listings of potential integration partners for the brand advertiser (e.g., movies, television shows, social media, music, video games) and the title of the showcase page (e.g., “Calvin Harris”).

Entertainment production showcase page 700 may be created using an online building process including uploading images, inputting information and completing text fields or questionnaires such as brand integration opportunities listings, overview descriptions (with information about type of entertainment, genre, rating and more), target audience/market demographics, others. Images may be uploaded through third party API's or via file, and the user may be able to view current images, upload different images, save images, close interfaces and/or adjust images. Overview data fields (ODF) may include information relevant to computing a brand advertiser's compatibility with an entertainment producer such as: type of entertainment (e.g., movie, television, music, video game, social media), release date, genre (e.g., comedy, thriller, rock music, racing game, action-adventure, or others) or sub-classification of entertainment (Instagram, YouTube, Twitter, or others). Target audience demographics questionnaires (TADQ) may include questions relevant to an entertainment's demographics, size, gender, age, household income, and location. Brand integration opportunities (BIO) may include entry fields relevant to computing a brand advertiser's compatibility with an entertainment producer such as: desired category of product/service, type of integration (visual, audio, audio/visual, storyline and more), integration deadline, context, screen time and more.

Typically, entertainment producers may only skip sections during showcase page creation in certain areas. Answers in each section may be saved upon a page exit by logging out, selecting a continue option, skipping to a next section, skipping directly to a search, clicking a persistent navigation link. When an entertainment producer returns to an incomplete section they may be presented with a first unanswered field in the section.

Sections which are incomplete may not contribute to compute compatibility. Completing ODF, TADQ, BIO may give a user the opportunity to view search results or a probability report in addition to a view showcase page button, dashboard button, or search button. If the user skips directly to a search, the entertainment producer may skip to automated search results or defined search builders depending upon what information the entertainment producer has previously provided.

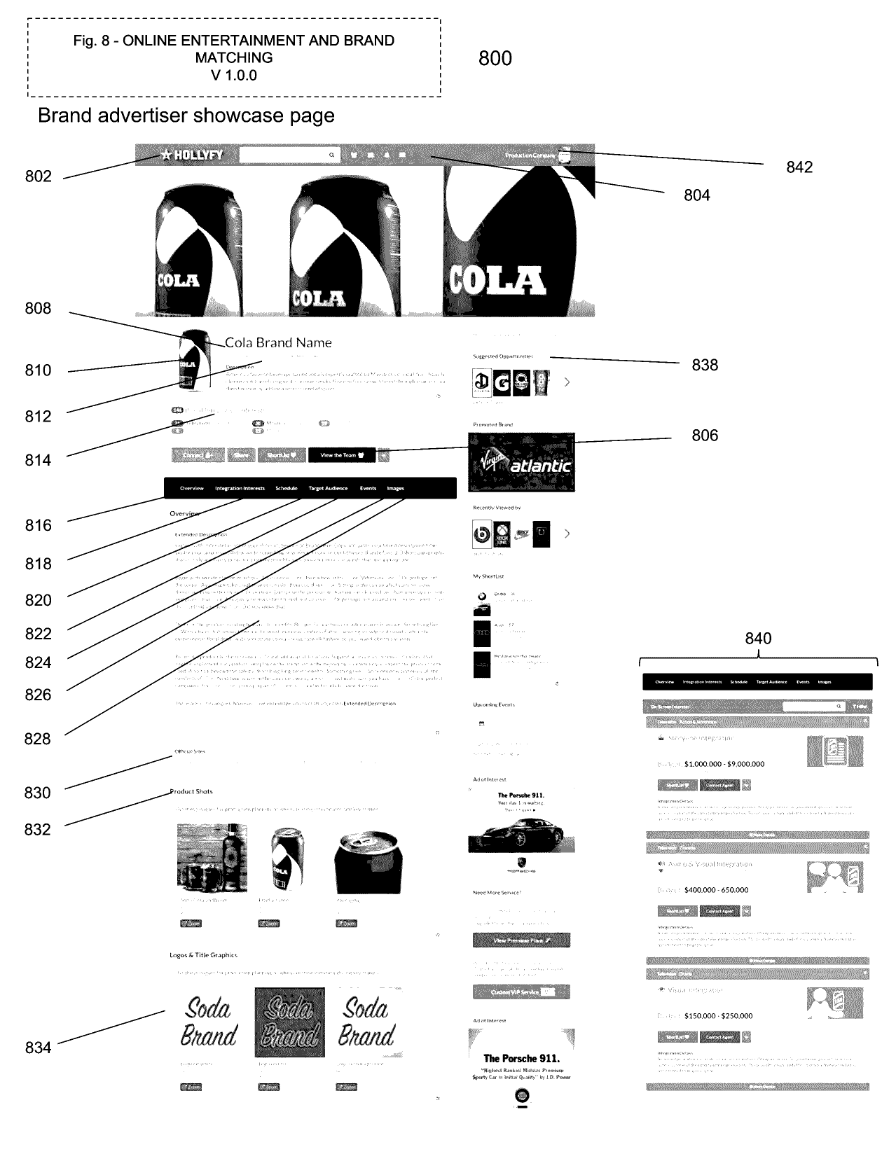

FIG. 8 shows an example embodiment of a brand advertiser showcase page 800 as it may be shown in an entertainment production user interface in accordance with the present invention. In the example embodiment, a title and/or homepage button 802 is shown. Although in the example embodiment it is located in the top-left of the interface, the title and/or homepage button 802 will generally be located in the top of the interface but, as with many other buttons and fields that will be described below, could be located elsewhere as appropriate. Informational navigation buttons 804 may include a “Search brand integration” field, a “Connections” button, a “Messages” button, a “Notifications” button, a “Listings” button, an active account identifier button 842 (“Hello, Production Company” in the example embodiment), a “Dashboard” button, and others. An account management selector within the account identifier button may include tools for a user to post “Integration Listings”, review “Upcoming Integrations”, adjust “Privacy Settings”, adjust “Account Settings”, manage “Connections” and others.

Brand advertiser showcase page 800 may include a name/title field 808 (e.g., “Soda Brand”) and a thumbnail image, photograph, or avatar location 810. In some embodiments, selecting this location may allow scrolling, viewing, or selecting additional images. Identifying information 812 may include information such as the type of brand (e.g., “Product/Beverage / Non-Alcoholic/Soda” in the example embodiment), Target date (“August 2018”), short description (“America's favorite beverage . . . ”). Brand integration listings 814 (“Total”, and types of listings relevant to the user, “Movie” in the example embodiment) show the current amount of brand integration interests and highlight the category relevant to the current user's interface. Also included may be different types of interactive buttons. In the example embodiment, these buttons include “Connect”, “Share”, “ShortList” the entire page to view later, “View the Team” profile, and other buttons. These interface tools may differ depending on membership, account validation and privacy settings.

The system may display numerous informative sections on a brand advertiser page 800 which describe aspects of the brand. In the example embodiment, an “Overview” section 816, “Integration Interests” section 818, “Schedule” section 820, “Target Audience” section 822, “Events” section 824, and “Images” section 826 are shown. An “Overview” section 816 may include 828 an “Extended Description” field, an “Official Sites” list 830 (e.g., Facebook, Instagram, website and others), a “Product Shots” images 832, and “Logos and Title Graphics” images 834.

In addition to the “Overview” section 816, the “Integration Interests” section 818 may show lists 840 of potential brand integration interests held by the brand advertiser. A “Most Relevant” list (e.g., Television/genre/budget) displays and sorts the listings according to values the user may find most relevant for their needs (e.g., listing similarities which align with an entertainment producer's listings; or, type of entertainment required by brand advertiser is similar to entertainment production user; or, target date aligns with release date; or, budget aligns with desired price; or, similar target audience/market demographics and others) these listings may be displayed in multiple locations. Graphical icons may be displayed in varying sizes relating to aspects of these listings and various colors may be used to highlight positive and negative attributes.

A “suggested opportunities” section 838 may be displayed in various locations and graphical iterations on the website. This section offers potential matches and may include images, information and listings of potential integration partners (e.g., type of product/service, sub-category, budget, and other details) and the title of the showcase page (e.g., “brand advertiser name”).

Brand advertiser showcase page 800 may be created using an online building process including uploading images, inputting information and completing text fields or questionnaires such as brand integration interest listings, overview descriptions (with information about type of brand, sub-categorization, target date and more.), target audience/market demographics, others. Images may be uploaded through third party APIs, or via file and user may be able to view current images, upload different images, save images, close interfaces and/or adjust images. Overview data fields (ODF) may include information relevant to computing a brand advertiser's compatibility with an entertainment producer such as: type of brand (e.g., beverage, alcoholic, rum), description of the brand, relevant details, or target date. Brand integration interests (BII) may include entry fields relevant to computing an entertainment production's compatibility with a brand advertiser such as: desired type of entertainment, genre, type of integration (visual, audio, audio/visual, storyline and more), integration deadline, context, screen time and more.

Target audience demographics questionnaires (TADQ) may include questions relevant to a brand's demographics, such as size, gender, age, household income, and location.

Brand advertisers may only skip certain sections during showcase page creation. Answers in each section may be saved upon a page exit by logging out, selecting a continue option, skipping to a next section, skipping directly to a search, clicking a persistent navigation link. When a brand advertiser returns to an incomplete section it may be presented with a first unanswered field in the section. Sections which are incomplete may not contribute to compute compatibility. Completing ODF, BII, and/or TADQ may give a user the opportunity to view search results or a probability report in addition to a view

showcase page button, dashboard button, or search button. If a user skips directly to a search the brand, advertisers may skip to automated search results or defined search builders depending upon what information the brand advertiser has previously provided.

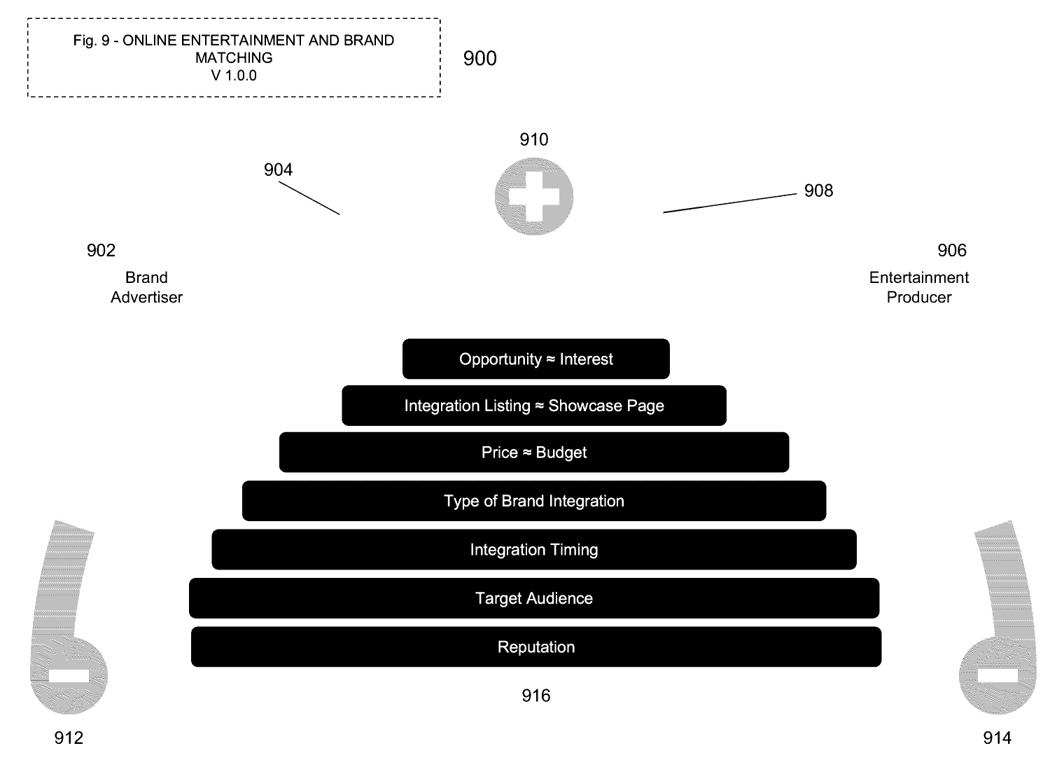

FIG. 9 shows an example generalized dynamic probability indicator 900 in accordance with the present invention. In the example embodiment a brand advertiser side 902 and entertainment producer side 906 are shown with brand advertiser ranking 904 and entertainment producer ranking 908. Also shown are a unified positive brand advertiser and entertainment producer indicator 910, negative brand advertiser indicator 912, and negative entertainment production indicator 914. Metric list 916 is shown in the center and may be color coded to intuitively show strong compatibility or weak compatibility as described previously for other metric comparisons.

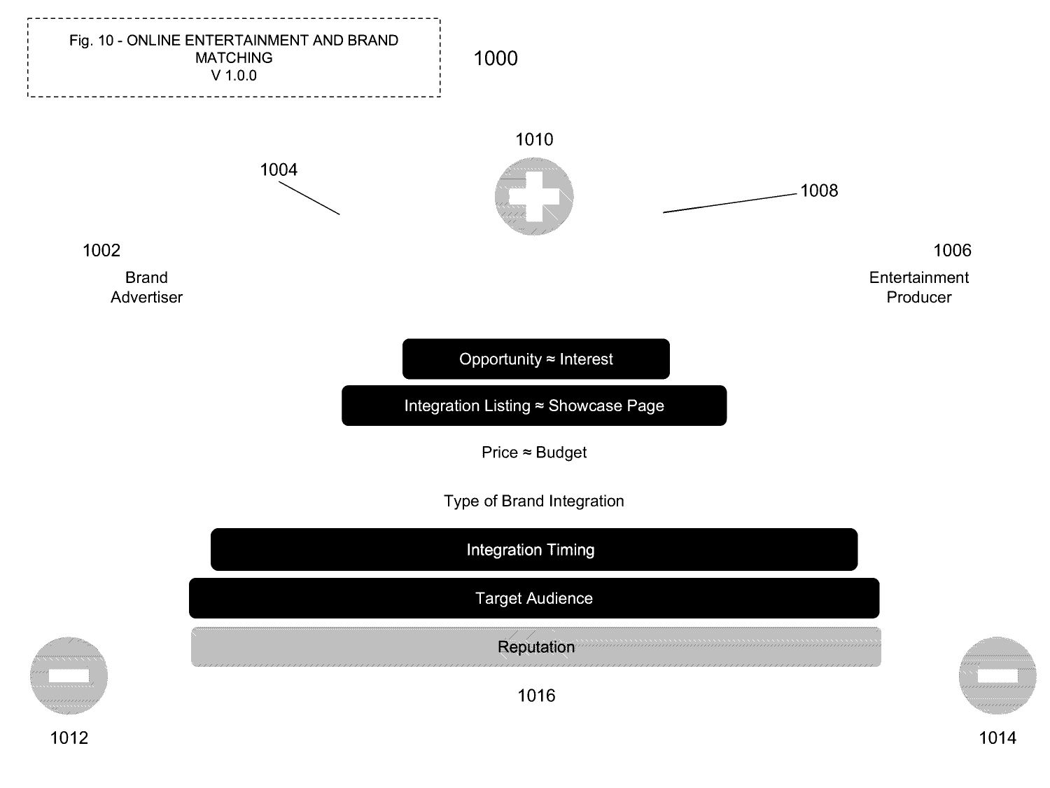

FIG. 10 shows a specific brand advertiser/entertainment producer dynamic probability indicator 1000 in accordance with the present invention. This indicator is similar in nature to the generalized dynamic probability indicator 900 shown in FIG. 9, but represents a comparison of a particular brand advertiser and entertainment producer. In the example embodiment a brand advertiser side 1002 and entertainment production side 1006 are shown with brand advertiser ranking 1004 and entertainment production ranking 1008.

Also shown are positive brand advertiser and entertainment production indicator 1010, negative brand advertiser indicator 10012 and negative entertainment production indicator 1014. Metric list 1016 is shown in the center and may be color coded to intuitively show high levels of compatibility or low levels of compatibility as described previously for other metric comparisons. In the example embodiment, the brand advertiser side 1002 ranks slightly more than the top 30%, indicating that the brand advertiser may be a better partner for the entertainment producer than nearly 70% of similarly situated brands. The entertainment producer side 1006 ranks at slightly less than the top 40%, indicating that the entertainment production may be a better integration partner for the brand advertiser than 60% of similarly situated entertainment producers. Black metrics in metric list 1016 include (Opportunity Interest), (Integration Listing Showcase Page) and (Target Audience), indicating that these metrics may be points of particular compatibility between the brand advertiser and entertainment production. Striped metrics in metric list 1016 include integration timing, thereby indicating that this metric may be a point of contention between the brand advertiser and entertainment production. White metrics in metric list 1016 include Price Budget and Type of Brand Integration, indicating that these metrics may be neutral between the brand advertiser and entertainment production. Gray metrics in metric list 1016 include reputation, indicating that the system may not have enough information to generate a probability score between the brand advertiser and entertainment production and more surveys, questionnaires, and/or analysis may need to be performed by the brand advertiser/entertainment production/system before a predictive metric can be generated.

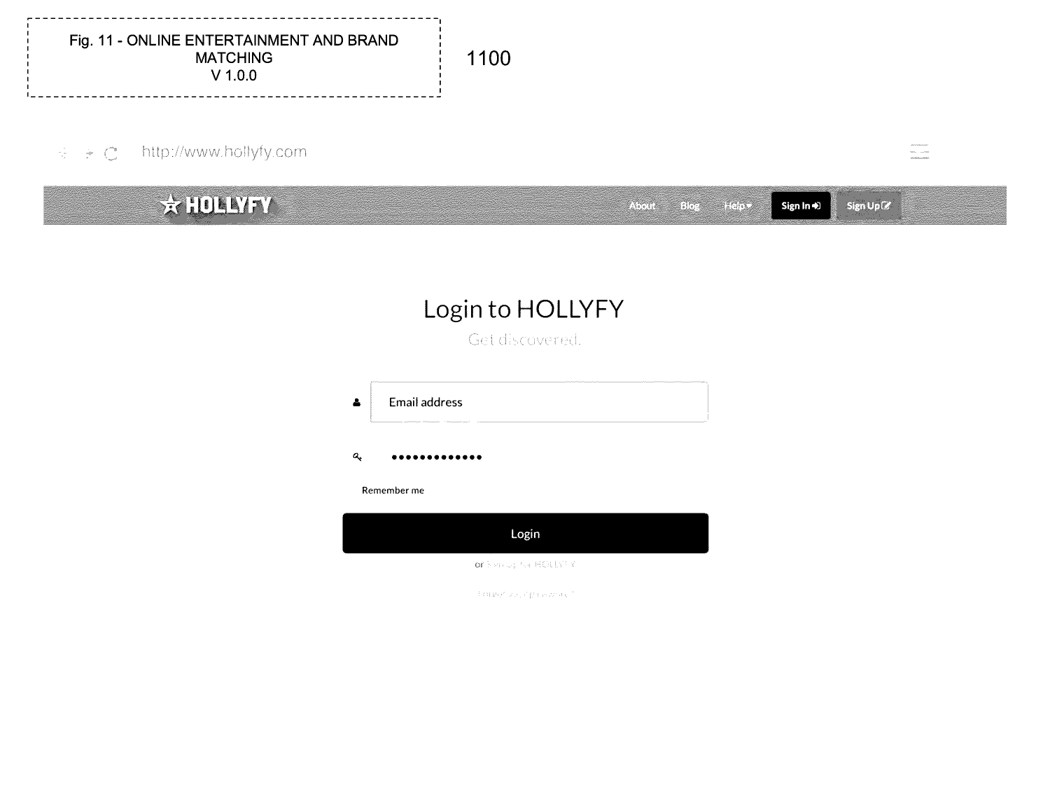

FIG. 11 shows an example embodiment of a system login screen 1100 in accordance with the present invention. Included are fields for returning users to enter a username/email address and password and fields for new users to sign up with an email address, password, and password confirmation.

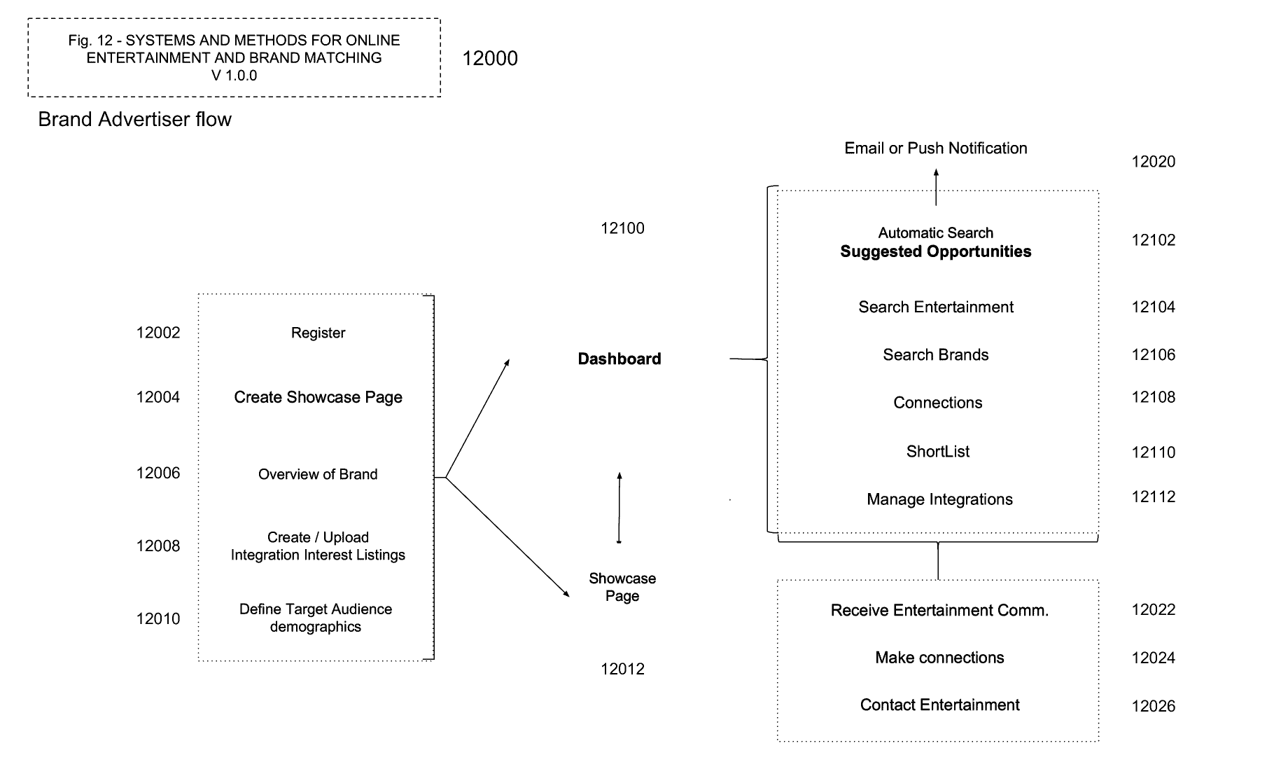

FIG. 12 shows an example embodiment of a brand advertiser flow map 12000 in accordance with the present invention. In the example embodiment, brand advertisers may initially register 12002 with profile information, create a showcase page 12004, provide overview details about the brand 12006, create/upload Integration Interest Listings 12008, define Target Audience demographics 12010 and review showcase page content 12012. Based on information identified in these sections, brand advertisers may advance to the dashboard 12100, review brand integration matches (“suggested opportunities”) 12102, or perform searches using search configuration tools 12104 and 12106, make connections 12108, review saved searches “shortlist” 12110 and manage brand integration 12112. The system may present automatic suggested opportunities 12102 and send email or push notifications 12020 to the brand advertiser. The brand advertiser may also receive entertainment production communications 12022, connect with other members 12024, contact entertainment producers 12026 and carry out other functions (not shown). In some embodiments, brand advertisers may be able to view previous entertainment productions used by brand advertisers in making operational decisions.

Integration searching for many brand advertisers may include the ability to search for brand integration opportunities using multiple criteria including: type of entertainment, genre, target audience size/demographics, type of integration, price, release date, integration deadline, and many others. Brand advertisers may also search for entertainment producers based on related connections, probability score for brand integrations, and others.

Brand advertisers may fall into various categories based on their status in the system. A first time user status may be incomplete about the brand advertiser. This status may mean that a brand advertiser has registered with the system but has not validated an account yet (for instance, by clicking a verification link in an email from the system to the brand advertiser's attempted registration email address). Brand integration seekers whose registration is incomplete may not be able to view entertainment productions/probability rankings, or search for brand integrations.

A second brand advertiser status may be a registered brand integration seeker. Brand advertisers with this status may have validated an account registration themselves (for instance, by clicking a verification link in an email from the system to the brand advertiser's registration email address), or have been registered by the system through other means (such as by linking a profile from social media, using customer service, or others). Registered brand integration seekers may be able to complete their brand advertiser profile and search for brand integrations using the system.

A third user status may be a subscribed brand integration seeker. Brand advertisers with this status may be registered brand integration seekers who have completed the additional step of paying for a subscription with the system (which is up to date and currently active). Subscribed brand integration seekers may be able to search and see all brand integration details available and have access to connect with other members using the system. Subscribed brand integration seekers may also be able to interact with entertainment producers using site communication tools such as messaging, etc.

Brand integration seekers may be further categorized to define available actions and system behaviors related to brand advertiser experience on the site, and also for internal and external business analytics and reports. Subscription statuses may be incomplete, pre-registered, registered, subscribed, expired, closed, flagged and/or others. Additionally, profile status information may include a determination as to whether the brand advertiser has completed one or more showcase page requirements such as inputting brand categorization criteria, integration interest listings, company profile, target audience demographics, image uploading and/or others. Subscribed brand integration seekers may be further categorized using an email status such as receives marketing emails, interested in promotions, receives newsletter emails, and/or receives match notification emails. Subscribed brand integration seekers may also be categorized as profile searchable and/or viewable depending on privacy settings.

Brand advertisers may receive various types of email messages and other notifications from the system in various embodiments. These may include notifications of generic matches, detailed matches, suggested opportunities, connections, contacts, shortlistings, promotions, applications, marketing, instructional, newsletters, administrative and more. Generic match notifications include notification of compatible brand integrations but may not provide specific information or contact links. Detailed match (suggested opportunities) notifications may include notification of compatible brand integrations with specific information and/or contact links. Connections, shortlisting or contact notifications may include notifications that an entertainment production has sent a message or ‘shortlisted’ an item. Marketing notifications may include marketing messages and promotions. Instructional notifications may include instructions and/or tips to assist users in optimizing their experience. Newsletters may include content relevant to the system experience in addition to the brand, and may entice brand advertisers into using the system. Administrative notifications may include notifications such as validation request for registration, notice of registration, notice of subscription, notice of renewal, notice of expiration, notice of closure, notice of account information change, notice of payment failure, notice of administrative action (such as suspension of account, etc.) and others.

Brand advertisers may receive various messages while using the system based on team role, status, recent activity and/or the activities of entertainment productions that have interacted with their information. These may include messages regarding unread messages, shortlistings, probability report review, subscription issues, page or profile completion, upcoming integrations, connection/friend/colleague referral, report/article recommendations, quiz/questionnaire taking, spring cleaning-to update brand integration listings, number of unread messages, number of un-reviewed matches and others.

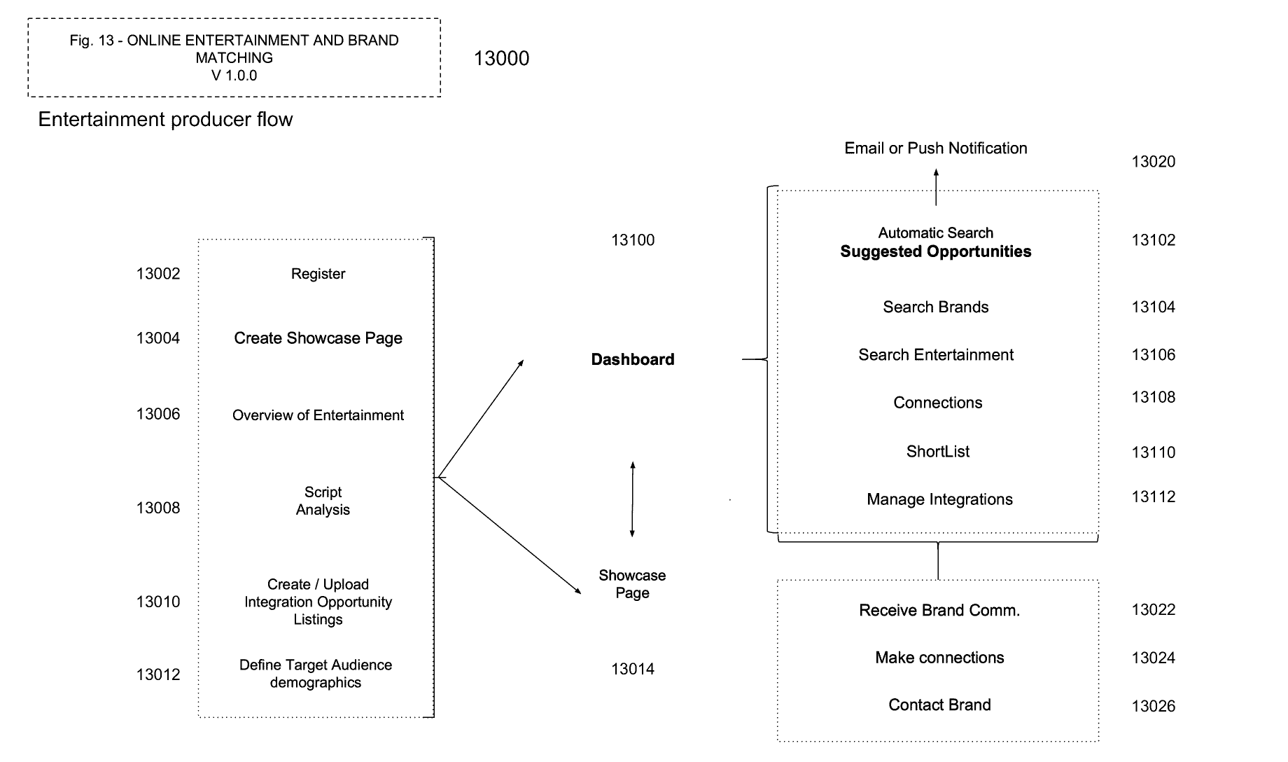

FIG. 13 shows an example embodiment of an entertainment production flow map 13000 in accordance with the present invention. In the example embodiment, entertainment productions may initially register 13002 with profile information, create a showcase page 13004, provide overview details about the entertainment 13006, utilize a script analysis to recommend listings 13008, create/upload integration opportunities listings 13010, define target audience demographics 13012 and review showcase page content 13014. Based on information identified in these sections, entertainment productions may advance to the dashboard 13100, review brand integration matches (“suggested opportunities”) 13102 or perform searches using search configuration tools 13104 and 13106, make connections 13108, review saved searches “ShortList” 13110 and manage brand integrations 13112. The system may present automatic suggested opportunities 13102 and send email or push notifications 13020 to the entertainment production. The entertainment producer may also receive brand advertiser communication 13022, connect with other members 13024, contact brand advertisers 13026, and carry out other functions not shown in FIG. 13. In some embodiments, entertainment producers may be able to view previous brand integrations of brand advertisers in making operational decisions.

Entertainment producers may fall into various categories based on their status in the system. A first entertainment producer status may be incomplete entertainment producer. This status may mean that an entertainment producer has registered with the system but has not validated an account yet (for instance, by clicking a verification link in an email from the system to the entertainment producer's attempted registration email address) and/or has not uploaded any brand integration listings to the system.

A second entertainment producer status may be a registered entertainment producer. Entertainment producers with this status may have validated an account registration themselves (for instance, by clicking a verification link in an email from the system to the entertainment producer's registered email address), or have been registered by the system through other means (such as by linking a profile from social media, using customer service, or others). Registered entertainment producers may also have at least one brand integration listing associated with an entertainment producer profile. Registered entertainment producers may search for brand advertisers relevant to the entertainment producer's brand integration listing(s) using the system but may be restricted from using custom searching tools. Registered entertainment producers may not be able to see brand advertisers' details or contact brand advertisers, and any brand integration listings an entertainment producer has uploaded to the system may not be searchable and/or viewable by a brand advertiser.

A third entertainment producer status may be subscribed entertainment producer. Entertainment producers with this status may be registered entertainment producers who have completed the additional step of paying for a subscription with the system (which is up to date and currently active). Subscribed entertainment producers may have brand integration listings searchable for brand advertisers using the system. Subscribed brand integration seekers may also be able to search for brand advertisers relevant for the entertainment producer's brand integration listing(s), may be able to search using custom parameters, may be able to see detailed brand advertiser information, and may be able to interact with entertainment producers using site communication tools such as messaging, etc.

Entertainment producers may be further categorized to define available actions and system behaviors related to entertainment production experience on the site, and also for internal and external business analytics and reports. Subscription statuses may include: incomplete—has not validated through link; pre-registered—does not require validation; registered—validated or logged as pre-registered; subscriber—paid and current subscription; expired—paid and lapsed subscription; closed; flagged and/or others.

Additionally profile status information may include a determination as to whether the entertainment production has completed one or more brand integration listings. Subscribed entertainment producers may be further categorized using an email status such as: receives marketing emails, receives newsletter emails, and/or receives match notification emails.

Entertainment producers may receive various types of email messages and other notifications from the system, in various embodiments. These may include notifications of generic matches, detailed matches, suggested opportunities, connections, shortlistings, contacts, applications, marketing, instructional, newsletters, administrative and brand integration requests. Generic match notifications may include notification of compatible brand advertisers that match a brand integration listing, but may not provide specific names of brand advertiser or profile information. Detailed match notifications may include notification of compatible brand advertisers that match a brand integration listing with specific information including brand names. Connections, shortlisting or contact notifications may include notifications that an entertainment production has sent a message or ‘ShortListed’ an item. Marketing notifications may include marketing messages and promotions. Instructional notifications may include instructions and/or tips to assist entertainment productions in optimizing their experience. Newsletters may include content relevant to the system experience in addition to the brand, and may entice entertainment productions into using the system. Administrative notifications may include notifications such as validation requests for registration, notices of registration, notices of subscription, notices of renewal, notices of expiration, notices of closure, notices of account information change, notices of payment failure, notices of administrative action (such as suspension of account, etc.) and others. Brand advertiser shortlist notifications may include notifications that a brand advertiser has expressed interest in one of the entertainment producer's brand integration opportunity listings.

Entertainment producers may receive various messages while using the system based on team role, status, recent activity and/or the activities of brand advertisers that have interacted with their information. These may include messages regarding unread messages, shortlistings, probability report review, subscription issues, page or profile completion, upcoming integrations, connection/friend/colleague referral, report/article recommendations, quiz/questionnaire taking, spring cleaning-to update brand integration listings, number of unread messages, number of un-reviewed matches and others.

In some embodiments, promotions, testing, and changes in activities and site behavior assigned to different user status values may be fluid, meaning that site behaviors and entertainment production/brand advertiser actions may change based on system permission or privacy settings. These fluid behaviors may include: automatic search functionality; page or listing visibility; custom search functionality—including searching based solely on user defined search terms; basic search functionality—including searching using a brand advertiser or entertainment production's target audience size/demographics; specific listings; newsfeed; status updates; assets; subscription level; ranking model; connections; sending communications; and/or others.

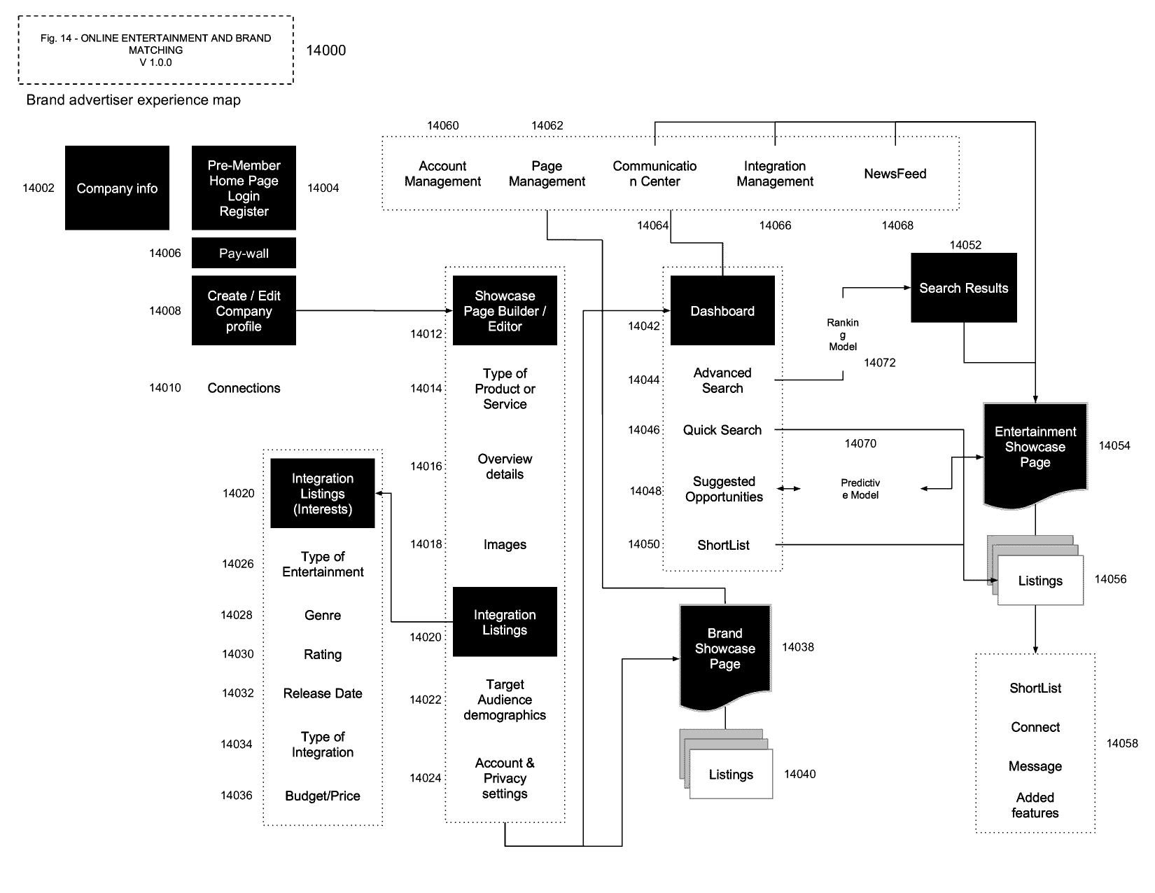

FIG. 14 shows an example embodiment of a brand advertiser experience map 14000 in accordance with the present invention. In the example embodiment, brand advertiser may find company information 14002 in the system prior to a home-page login/register 14004. This may occur using search engines, advertising, social media or other means. Registration may include web-form registration with email validation, third party API registration (such as through social media sites or search engines), and pre-registration through administrative action. Registration may utilize a pay-wall 14006 which requires the user to become a paying subscriber before allowing additional functionality.

Some functionality includes automatic search results (suggested opportunities) based on probability, build/create pages, build/refine search based on multiple criteria and weights, view integration listings, view detailed company and probability information for each integration listing, shortlist, save searches, make connections, receive notification of matches with compatible opportunities, view matched opportunities, view content and tips from integration specialists, respond to communications from entertainment representatives and others, any or all of which may be located behind pay-wall 14006. Once a brand advertiser has logged in or registered, the brand advertiser may create and/or edit a brand advertiser profile 14008 or connect to other sites (such as LinkedIn) 14010. A brand advertiser may use a showcase page builder/editor 14012. A showcase page builder may contain sections used to define, categorize or index the brand (e.g., brand name, type of product/service 14014, descriptive overview details 14016, relevant images 14018, target audience demographics 14022, and account/privacy settings 14024). Brand advertisers may be able to add multiple integration interest listings 14020 in some embodiments. These integration listings 14020 assist the brand advertiser to find partnerships with appropriate entertainment productions 14054. To efficiently align integration listings 14020 the system may then present a brand advertiser with data entry fields or questionnaires such as: type of entertainment 14026, desired genre or sub-classification of entertainment 14028, entertainment rating 14030, release date 14032, type of desired integration (visual, audio, audio/visual, storyline, and others) 14034, budget/price of integration 14036, and others. The system may display a dashboard 14042 including sections for account management 14060, showcase page management 14062, communication center 14064, integration management 14066, newsfeed 14068, and others. In the example embodiment, within the dashboard 14042 and/or in other locations, the brand advertiser may view suggested opportunities 14048 which are derived using the predictive model 14070 to view potential partners and the correlated entertainment showcase page 14054 as well as relevant integration listings 14056. Additional methods and systems on the brand advertiser dashboard 14042 include advanced search functionality 14044, which utilizes a ranking model 14072, which sorts for successful partnerships based on user behavior and correlated patterns. Other dashboard features include a quick search function 14046, and a ShortList 14050 of the brand advertiser's preferred entertainment pages 14054 or integration listings 14056. In the example embodiment, additional functionality includes viewing entertainment showcase page details 14054, receiving detailed probability reports for each opportunity, communicating with entertainment productions, shortlist/save searches, connect with other members, messaging other users, accessing a mobile application and others 14058.

Brand advertisers searching for entertainment producers may search in at least three ways. First is an automatic search (suggested opportunities), which includes searching and ranking based on an automatic process solely using an available brand integration listing or page. Second is a refined advanced search, which includes searching and ranking based on user defined search terms in combination with a ranking model and an automatic process based on an available brand integration listing. Third is a custom search, which includes searching and scoring based solely on user defined search terms. In many embodiments, brand advertisers must be subscribers in order to use search capabilities.

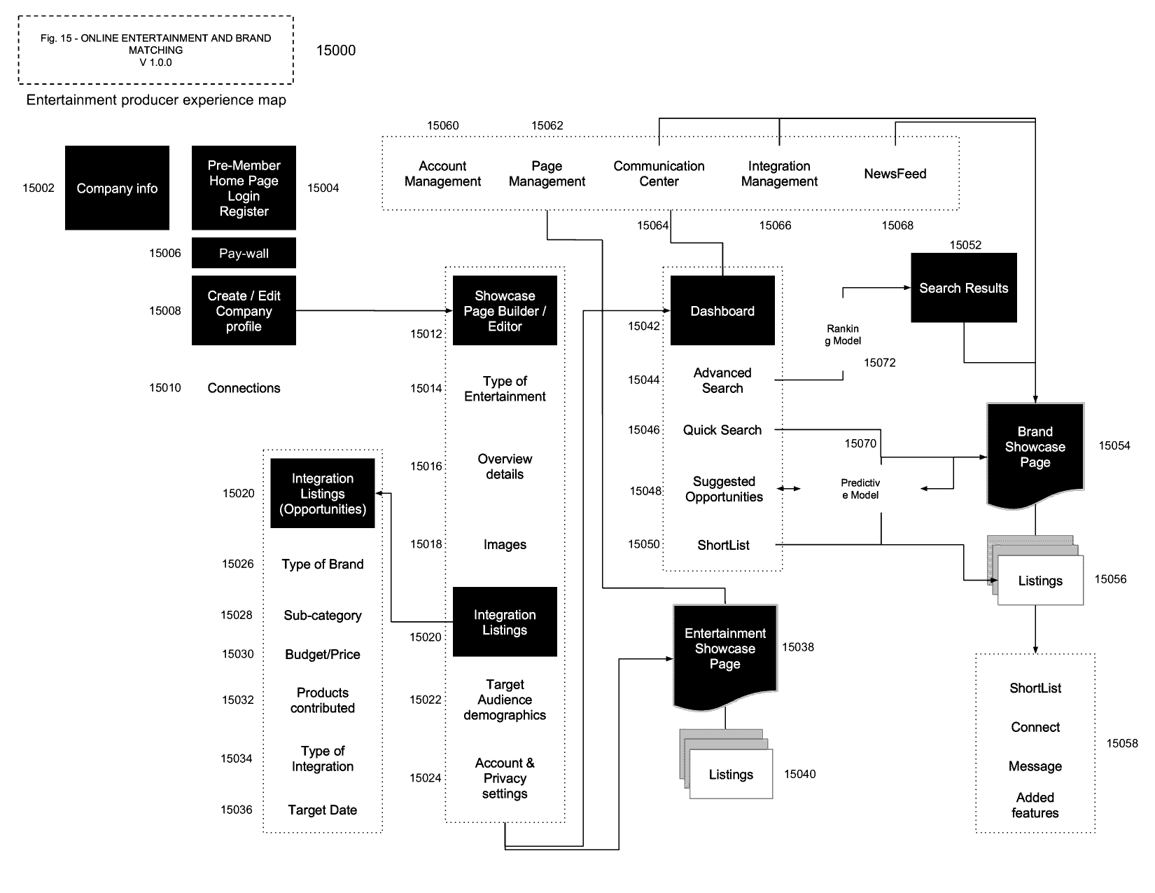

FIG. 15 shows an example embodiment of an entertainment production experience map 15000 in accordance with the present invention. In the example embodiment, an entertainment producer may find company information 15002 in the system prior to a home-page login/register 15004. This may occur using search engines, advertising, social media or other means. Registration may include web-form registration with email validation, third party API registration (such as through social media sites or search engines), and pre-registration through administrative action. Registration may utilize a pay-wall 15006 which requires the user to become a paying subscriber before allowing additional functionality. Some functionality includes: automatic search results (suggested opportunities) based on probability, build/create pages, build/refine search based on multiple criteria and weights, view integration listings, view detailed company and probability information for each integration listing, shortlist, save searches, make connections, receive notification of matches with compatible opportunities, view matched opportunities, view content and tips from integration specialists, respond to communications from brand representatives, and others, any or all of which may be located behind pay-wall 15006.

Once an entertainment producer has logged in or registered, the entertainment producer may create and/or edit an entertainment producer profile 15008 or connect to other sites (such as LinkedIn) 15010. Entertainment producer may use a showcase page builder/editor 15012. A showcase page builder may contain sections used to define, categorize or index the brand (e.g., entertainment title, type of entertainment or genre 15014, descriptive overview details 15016, relevant images 15018, target audience demographics 15022, and account/privacy settings 15024). Entertainment producers may be able to add multiple integration opportunity listings 15020 in some embodiments. These integration listings 15020 assist the entertainment producer to find partnerships with appropriate brand advertisers 15054. To efficiently align integration listings 15020 the system may then present entertainment producer with data entry fields or questionnaires such as: type of brand 15026, desired sub-category of brand 15028, budget/price 16030, number of products contributed 15032, type of desired integration (visual, audio, audio/visual, storyline, and others) 15034, target date 16036, and others. The system may display a dashboard 15042 including sections for account management 15060, showcase page management 15062, communication center 15064, integration management 15066, newsfeed 15068, and others. In the example embodiment, within the dashboard 15042 and/or in other locations the entertainment production may view suggested opportunities 15048 which are derived using the predictive model 15070 to view potential partners and the correlated brand showcase page 15054 as well as relevant integration listings 16056. Additional methods and systems on the entertainment production dashboard 15042 include advanced search functionality 15044, which utilizes a ranking model 15072 which sorts for successful partnerships based on user behavior and correlated patterns. Other dashboard features include a Quick search function 15046, and a shortlist 15050 of the entertainment production's preferred brand advertiser pages 15054 or integration listings 15056. In the example embodiment, additional functionality includes viewing brand advertiser showcase page details 15054, receiving detailed probability reports for each opportunity, communicating with brand advertisers, shortlist/save searches, connect with other members, messaging other users, accessing a mobile application and others 15058.

Entertainment producers searching for brand advertisers may search in at least three ways. First is an automatic search (suggested opportunities) which includes searching and ranking based on an automatic process solely using an available brand integration listing or page. Second is a refined advanced search, which includes searching and ranking based on user defined search terms in combination with a ranking model and an automatic process based on an available brand integration listing. Third is a custom search which includes searching and scoring based solely on user defined search terms. In many embodiments, entertainment producers must be subscribers in order to use search capabilities.

FIG. 16 shows a schematic of dependencies in an example embodiment using interoperability between an entertainment and brand partnership predicting program 16006 and third party production/audience aggregator 16008 in accordance with the present invention. In the example embodiment, brand advertiser 16002 and entertainment producer 16004 can independently sign up for entertainment and brand matching system 16006. Users sign up for brand integration partnership predicting program using registration 16010 that may present brand advertiser 16002 and entertainment producer 16004 (through representatives such as agents and others). Additionally, entertainment and brand matching system 16006 may perform matching of brand advertisers 16002 and entertainment producers 16004 using the predictive matching model 16020, and store results in database 16012, in integration interests database 16014, and brand showcase page database 16016. In one embodiment, if the input is a brand advertiser, the brand integration interests and brand showcase page is stored in the information database 16012. Alternatively, if the input is an entertainment production, the integration listings and entertainment offering page information is stored in database 16026. Information from database 16012 may become an input to a partnership ranking 16018, the result of which may be used in brand integration listings and ranking database 16034, and used to create matches that are delivered to brand advertisers or entertainment producers with the predictive matching model 16020. Scoring a match does not mandate delivering it as a match. The mechanism for ranking something, even if those define a high probability as a match, is not the same mechanism as selecting a match. Selection may be dependent upon numerous scores and numerous independent business factors.

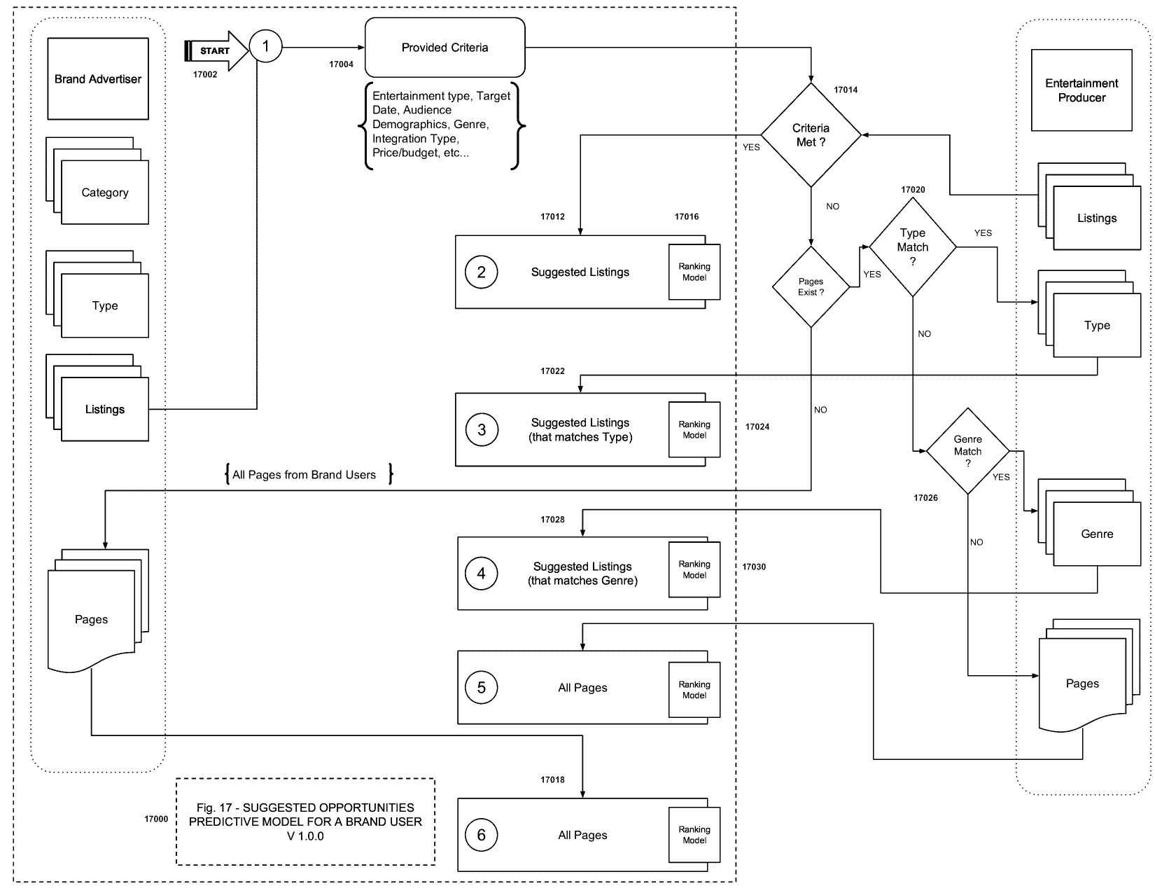

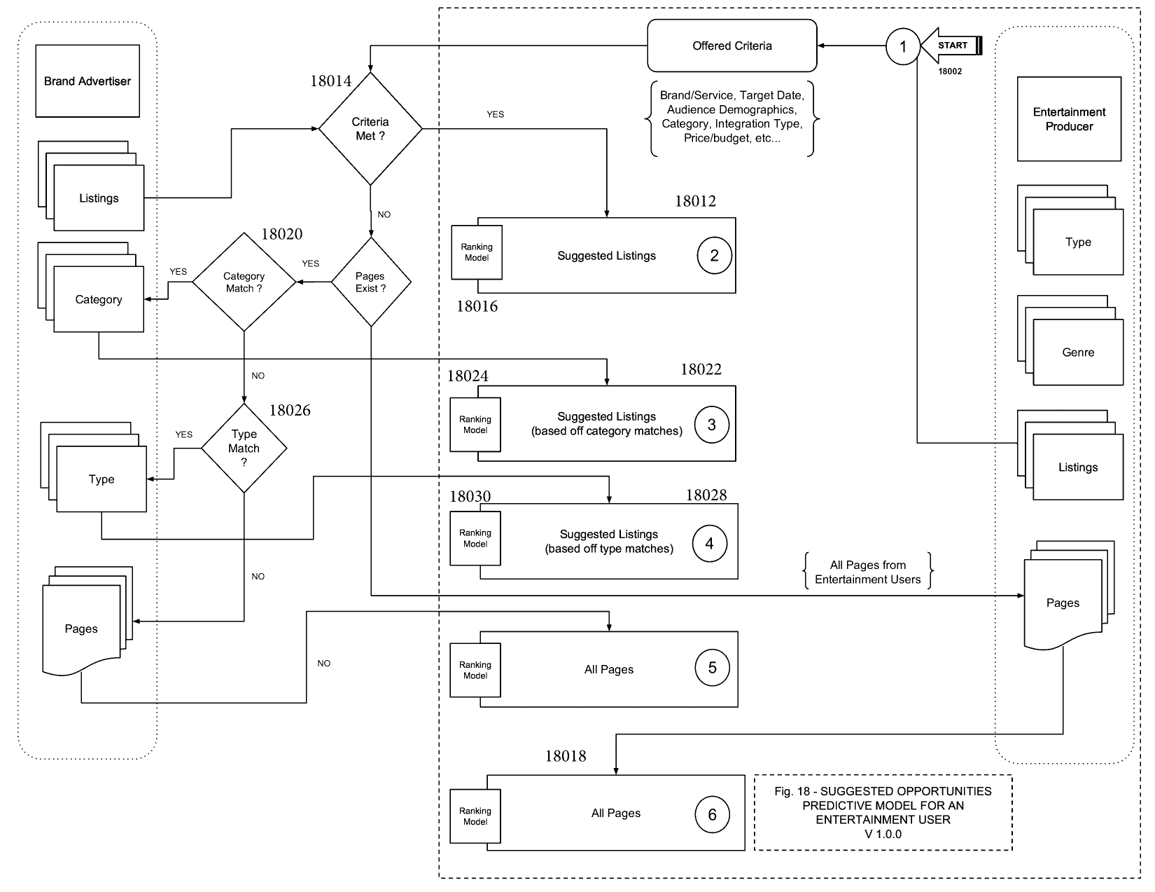

Third party production/audience aggregator 16008 may send information to parser 16024 which also receives information from entertainment and brand matching system 16006. Parser 16024 may parse queries, target audience data, corporate data points, and brand integration listings, and organize data into feature sets with unique taxonomies. Matching model 16020 sends information to database 16026, which includes integration opportunities database 16030 and entertainment showcase page database 16028. Matching model 16020 may be a similarity matching algorithm, which in some embodiments is based on Bayesian models, and may predict integrations based on a comparison of integration needs, budgets/prices, types of integration, target audience demographics, or other attributes possessed by a brand advertiser's requirements and/or entertainment production's requirements. Information from database 16026 may be used by ranking model 16032, which may output information to integration listings and ranking database 16034. Information from integration listings and ranking database 16034 may be used in matching model 16020. The predictive matching model is further described in FIGS. 17 and 18 below.

In some embodiments, some or all members of an integration partnership predicting program may automatically be offered membership in brand integration matching program 16006, while in other embodiments specialized criteria may be used to select members for brand integration matching program 16006.

Partnership ranking 16018 may use correlational models in order to calculate predictive scores. These models may be created using self-provided information of users of integration partnership predicting program 16020, the information including type of entertainment, type of brand, target audience/market demographics, pricing/budget, type of integration, and other preferential information to create scores for a number of predetermined factors, and then using those factors to predict individual brand integration alignment and performance across other similar members.

FIG. 17 shows an example embodiment of an automatic suggested opportunities search flow 17000 for a brand advertiser in accordance with the present invention. In one embodiment, the search flow 17000 is a three-tiered search that searches for matches between a brand advertiser listing and potential entertainment offering listings. The search flow 17000 can also search for matches based on the type of the brand advertiser and the entertainment producer. Furthermore, search flow 17000 can also search for matches based on the genre of the brand advertiser and the entertainment producer. Suggested opportunities allow for search and ranking based on an automatic process based on available brand advertiser information. In the example embodiment, a brand advertiser may select suggested opportunities 17002 from within an entertainment and brand search system. The system may first automatically determine whether a member's page and listings are available, or prompt a user with a suggestion to add more data.

In cases where a listing is available 17004, the system may then determine the percentage of criteria values available, and correlate them in step 17014. In one embodiment, the system computes a probability score using the scoring function described above in FIG. 6. In this embodiment, for each pair of brand integration and entertainment listings, the system computes a score for this pair using the scoring function. In one embodiment, the system computes the score for the listings pair using the scoring function based on at least the taxonomies for each of the brand listing and the entertainment offering. In one embodiment, if the score for this listing pair is greater than a threshold, the system marks this listing pair as being available as an integration listing and showcase page. In cases where an integration listing and showcase page is available, the system may submit the suggested opportunity from step 17012 to a ranking model in step 17016. While in one embodiment, the system ranks the entertainment opportunity listings that match the brand integration listings using the results of the scoring function, in alternate embodiments, the system can rank the entertainment opportunity listings using the results of the scoring function and other types of values (e.g., account activeness, offerings score, page view score, shortlist score, connections score, newness score, spam and reports score, and others as described above in FIG. 5). In cases where no pages exist from step 17014, the system may allocate all existing pages 17018. The system can additionally rank the existing pages using the ranking model.

In cases where an entertainment type is available, the system may submit the showcase pages of the brand integrations to a partnership match in step 17020. In one embodiment, the system determines if there are matches between the types for the brand integration listings and the entertainment producer type. In one embodiment, the type of the brand integration listing is a primary factor of an entertainment type to be requested by the brand advertiser for this listing (e.g., television, movie, music, video game, social media, or virtual reality). This entertainment type is matched against the type of entertainment for each of the entertainment producers. The system proceeds to show the listings whose type matches with the submitted type 17022. A ranking model 17024 is used to sort the results, which will then be displayed to the user.

In cases where an entertainment genre is available 17026, the system may submit the showcase pages of the brand integrations to a partnership match. In one embodiment, the system determines if there are matches between the genres for the brand integrations and the entertainment offering listings. In one embodiment, the genre is the secondary factor of an entertainment type to be requested by the brand advertiser for this listing (e.g. television (e.g., action, adventure, drama, comedy, family, etc.), movies (e.g., action, adventure, drama, comedy, family, etc.), music (e.g., pop, hip-hop, country, jazz, classical, etc.), video games (e.g., shooter, role-playing, etc.), social media (e.g. Twitter, Facebook, LinkedIn, etc.), and/or virtual reality (e.g., video games, movies, augmented reality, etc.)). This entertainment type is matched against the type of entertainment for each of the entertainment producers. The system will then proceed to show all the listings whose genre matches with the submitted genre 17028. A ranking model 17030 is used to sort the results, which will then be displayed to the user.

FIG. 18 shows an example embodiment of an automatic suggested opportunities search flow 18000 for an entertainment producer in accordance with the present invention. Suggested opportunities allow for search and ranking based on an automatic process based on available brand information. In one embodiment, the search flow 18000 is a three-tiered search that searches for matches between an entertainment offering listing and potential brand integration listings. The search flow 18000 can also search for matches based on the type of the entertainment offering listing and the brand advertiser. Furthermore, search flow 17000 can also search for matches based on the genre of the entertainment offering and the brand advertiser. In the example embodiment, an entertainment producer may select suggested opportunities 18002 from within an entertainment and brand search system. The system may first automatically determine whether a member's page and listings are available or prompt a user with a suggestion to add more data.

In one embodiment, a search and match model similar to that used for FIG. 17 can be employed to provide suggested opportunities for the entertainment production user. In cases where a listing is available 18004, the system may then determine the percentage of criteria values available, and correlate them in step 18014. In one embodiment, the system computes a probability score using the scoring function described above in FIG. 6. In this embodiment, for each pair of entertainment offering and brand integration listings, the system computes a score for this pair using the scoring function. In this embodiment, the system computes the score for the listings pair using the scoring function based on at least the taxonomies for each of the brand listing and the entertainment offering. In one embodiment, if the score for this listing pair is greater than a threshold, the system marks this listing pair as being available as an integration listing and showcase page. In cases where an integration listing and showcase page is available, the system may submit the suggested opportunity from step 18012 to a ranking model in step 18016. While in one embodiment, the system ranks the entertainment opportunity listings that match the brand integration listings using the results of the scoring function, in alternate embodiments, the system can rank the entertainment opportunity listings using the results of the scoring function and other types of values (e.g., account activeness, offerings score, page view score, shortlist score, connections score, newness score, spam and reports score, and others as described above in FIG. 5). In cases where no pages exist from step 18014, the system may allocate all existing pages 18018. The system can additionally rank the existing pages using the ranking model.

In cases where a category is available for the brand advertiser, the system may submit the showcase pages of the entertainment offerings to a partnership match in step 18020. In one embodiment, the system determines if there are matches between the types for the categories of the brand advertisers and the entertainment offering listings. In one embodiment, the category is the primary factor of brand to be matched for the entertainment offering (e.g., apparel, body care, software, etc.). These categories are matched against the brand category for each of the entertainment offering listings. The system proceeds to show the listings whose category matches with the submitted type 18022. A ranking model 18024 is used to sort the results, which will then be displayed to the user.

In cases where a brand advertiser type is available 18026, the system may submit the showcase pages of the entertainment offerings to a partnership match. In one embodiment, the system determines if there are matches between the types for the brand integrations and the entertainment offering listings. In one embodiment, the type is the secondary factor of brand advertiser to be requested by the entertainment offering listings. If a primary factor is a broad type of brand/service (e.g., apparel, body care, software, etc.), a secondary factor a further refinement of the primary factor (e.g., women's clothing, shampoo, video games, etc.). This brand advertiser type is matched against the integration type of entertainment for each of the entertainment offering listings. The system will then proceed to show all the listings whose type matches with the submitted type 18028. A ranking model 18030 is used to sort the results, which will then be displayed to the user.

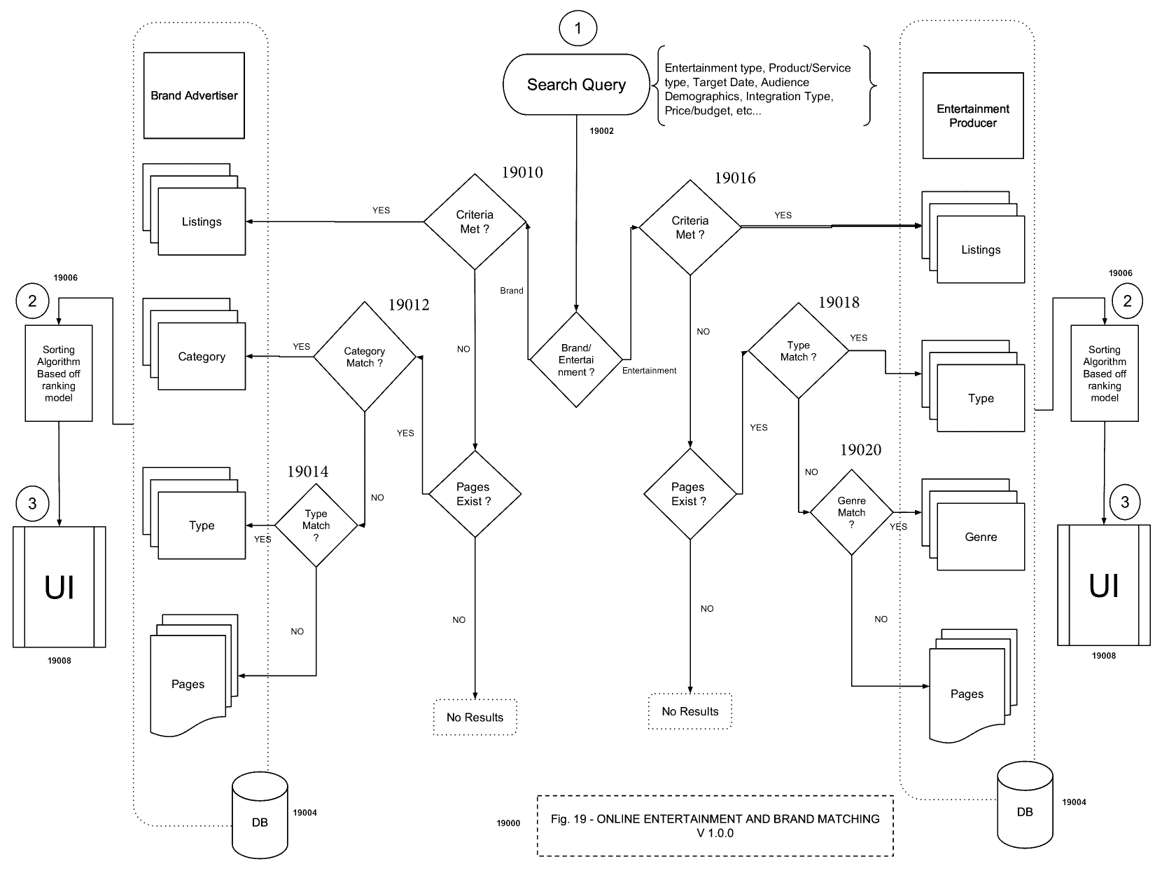

FIG. 19 shows an example embodiment of a refined brand integration search flow 19000 in accordance with the present invention. Refined searches allow for search and ranking based on user defined search terms including criteria and weights in combination with the automatic process based on the user's showcase page, brand integration listings and/or profile information. Search queries may be displayed on custom search builder pages, custom search results pages, automated search results pages, refined search results pages, and basic search results pages. In the example embodiment, the system receives a user defined search in step 19002 such as a search term and parameter category. In some embodiments, searches may be saved and resubmitted at later times.

Auto-complete may be used in some embodiments to suggest words or phrases. Users may be able to rank importance of a particular search term including low, medium, high, must have, and others. In some embodiments, numerous search parameters may be used, up to twenty-five or more. In some embodiments, the number of search parameters may be limited, and users may be required to remove some before new ones are accepted. The system then submits a query to an electronic database 19004 and collects a list of opportunities, which may be limited, or may not be in different embodiments. Next the system may determine whether a showcase page and integration listings are available and prompt the user to provide details if not (19010 for brand integration listings, 19016 for entertainment offering listings). If a page and listings are available then the system may submit the data and collect or compile a list with similarity matches 19006 and display relevant matches in accordance with the embodiment of the user interface 19008.

In case a match for a brand integration or entertainment offering listing using the entertainment type cannot be established, the system looks for the presence of several other search parameters, for example: integration type, genre, deadline, release date, target audience, product/service type, entertainment type, price/budget and others. A query to the electronic database 19004 will retrieve all listings or pages based on the tier 2 parameters in the search query, and compile relevant content.

If the search is for a brand advertiser and does not produce a match searching the brand integration listings, the system determines if pages exist. If no pages exist, the search yields no results. If pages exist, the search further determines if the search matches a category of one or more brand advertisers (19012). If there is a match, the matching brand advertisers are displayed. If there is not a match, the search determines if there is a match based on the type of brand advertiser (19014). If there is a match, the matching brand advertisers are displayed. If there is no match, all pages are displayed. In one embodiment, the matching and/or displayed pages can be ranked using the ranking model.

If the search is for an entertainment offering and does not produce a match searching the entertainment offering listings, the system determines if pages exist. If no pages exist, the search yields no results. If pages exist, the search further determines if the search matches a type of one or more entertainment producers (19018). If there is a match, the matching entertainment producers are displayed. If there is not a match, the search determines if there is a match based on the genre of entertainment producers (19020). If there is a match, the matching entertainment producers are displayed. If there is no match, all pages are displayed. In one embodiment, the matching and/or displayed pages can be ranked using the ranking model.

Search results may be displayed for automated searches, refined searches, custom searches, and basic searches. For automated searches, if the user provided an integration interest/opportunity listing, or provided sufficient information and completed the overview section of their Showcase Page, and/or completed the target audience section, then the user will receive automated search results that are based on integration probability (if available), audience/market alignment (if available), and price/budget similarity (if available). For refined searches, if the user refined an automated search, the results will be generated using a query built from the user's industry and integration listings and newly entered search terms, and then ranked for partnership. For custom searches, if the user performs a custom search, the results will be generated using a query built solely from the terms and weights provided. No probability ranking will be performed. Ranking may be by search fit. For basic searches, the results may be based only on the brand integration seeker's industry, ranking model and current membership level.

Search results may provide users with a high level overview of the brand integration. Contents may vary according to member status. For subscribers, company name/title, overview details, brand/entertainment types, team info, integration listings, schedule, target audience demographics, and relevant images may be displayed. For registered users who have not completed their showcase page and profile to the satisfaction of the system, then de-branded data may be displayed.

Default rankings for search results generally will be listed with best match first. Algorithms may take integration fit, target audience, price/budget, and search fit into account. If no probability data is available, a default ranking may be a search fit based on a user's search parameters. Users may sort brand integration search results using search fits, integration fits, audience fits, type/category fits, newest fits, and best match fits.

Each brand integration result may allow a user (who has the required status) to shortlist the opportunity/interest, connect/message the other member, view a detailed listing, close a listing/page such that it will never be displayed again to the user, or flag a listing/page such that an alert will be sent to an administrator. If a listing/page is risky or non-existent, as determined by an administrator, the listing/page may be disabled and not displayed to other users.

Shortlisted pages or listings may automatically be saved in case a user accidentally or purposefully exits a search window.

Probability reports which the system may generate may include detailed reports regarding the brand integration, brand advertiser and the entertainment producer. Probability reports may include information about how compatible the brand advertiser is with the entertainment producer's opportunities, how well the correlated listings fit the requirements of the other member, what type of brand/entertainment possesses a higher rate of success, and what type of professional the user is.

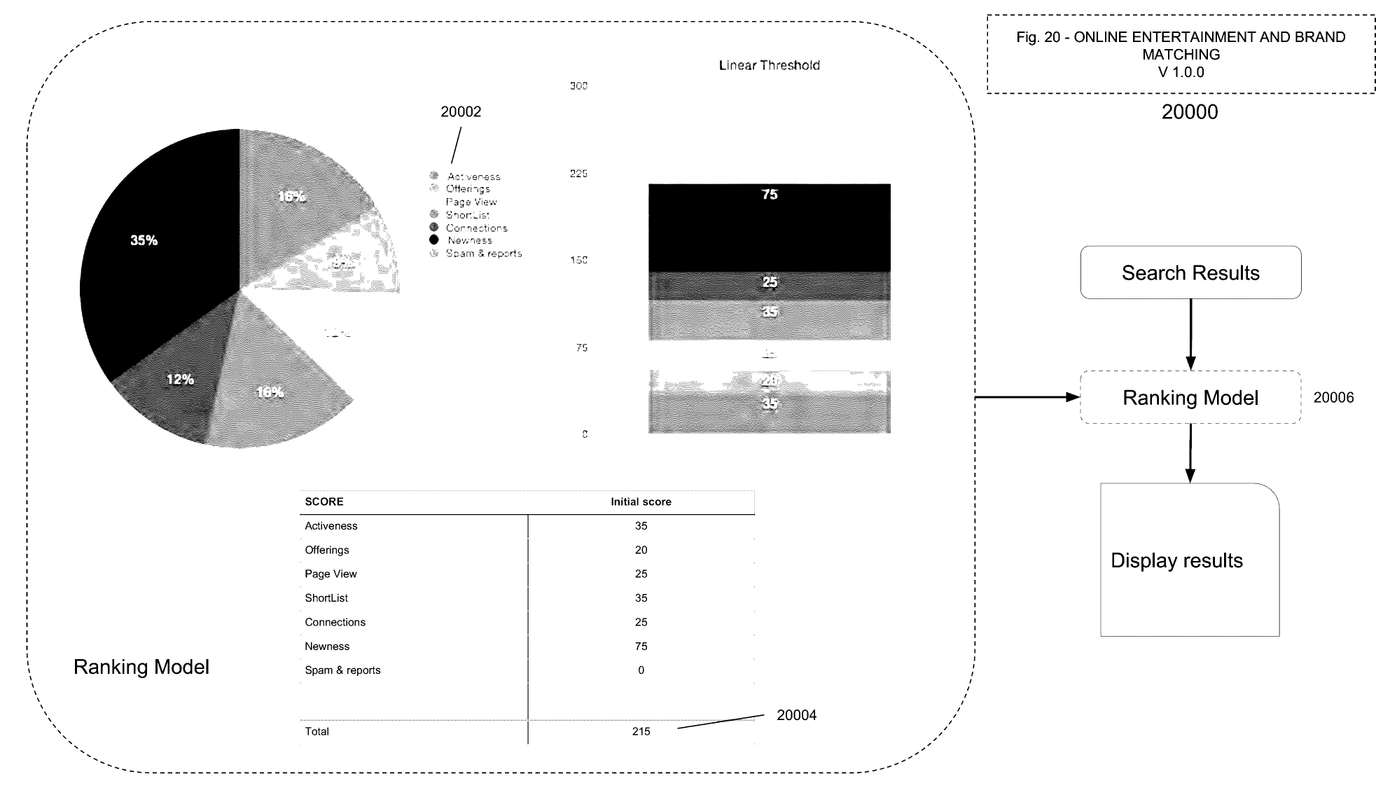

FIG. 20 shows an example embodiment of a customer ranking model 20000 in accordance with the present invention. Seven major components 20002 were identified and will contribute to a calculated customer score 20004. The score is directly proportional to the quality of the customer, and a higher score for a given component may increase or decrease the customer score when using ranking model 20006.

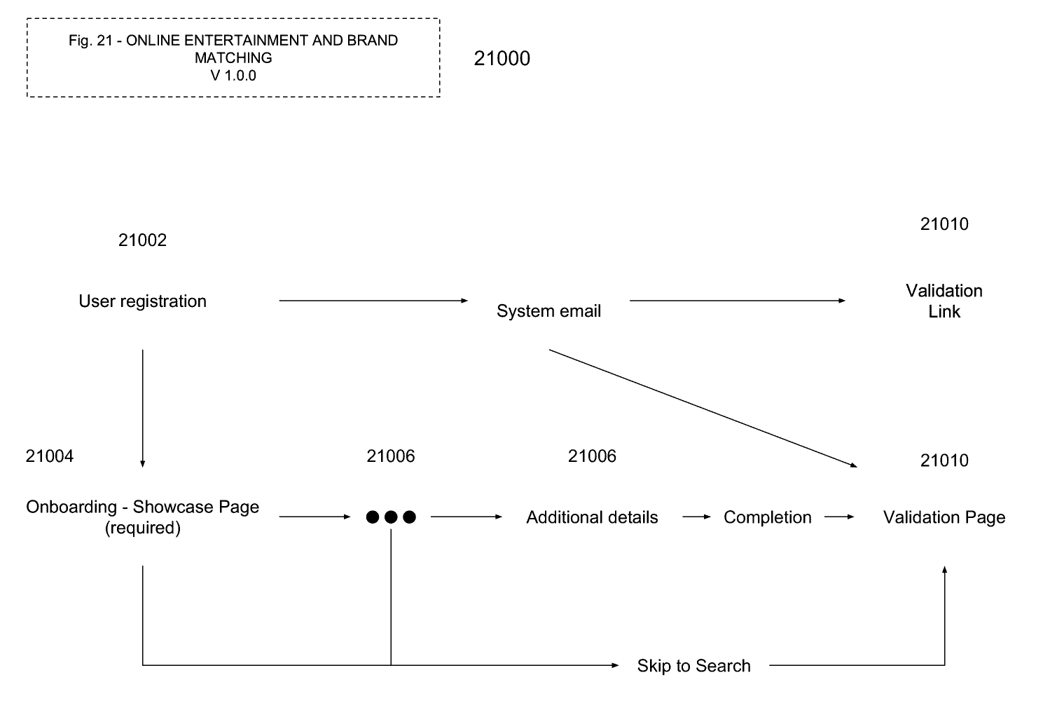

FIG. 21 shows an example embodiment of an e-mail registration flow for a user 21000 in accordance with the present invention. Registration may be required when a brand advertiser or entertainment producer seeks to search for brand integrations. In the example embodiment, the system may recognize a brand advertiser or entertainment producer registration in step 21002. This may include using a web form or third party API. In embodiments where a web form is used, a user may need to fill out required fields such as first name, last name, email address, valid password, and password confirmation. In embodiments where third party APIs are used, a user may need to grant the system access to all required permissions. The system may then automatically generate a system email with an included validation link and send it to the email address provided by the user. The user may then select or follow the link provided in step 21010 in order to validate the associated brand advertiser or entertainment producer profile/page. If a user does not successfully validate an account, then the user may be prompted to resend a validation email to the current email address or to a new email address. Upon a successful user registration in step 21002, the system may prompt the user to onboard details to construct a showcase page in step 21004. The system may then prompt the user to complete numerous other steps 21006, which may include entering brand integration criteria, selecting relevant data fields that supply information, uploading images, add brand integration listings, completing questionnaires, filling out surveys, etc., in step 21006. The system may then prompt a user to complete a series of additional content fields such as: add more listings, refine audience/market demographics, upload more images, add cast/crew and others in step 21008. At any point between and including steps 21004 and 21008, the system may allow a user to skip directly to a search function and validation step 21010. A user may also arrive at step 21010 from a system e-mail or by completing all steps 21004 through 21008.

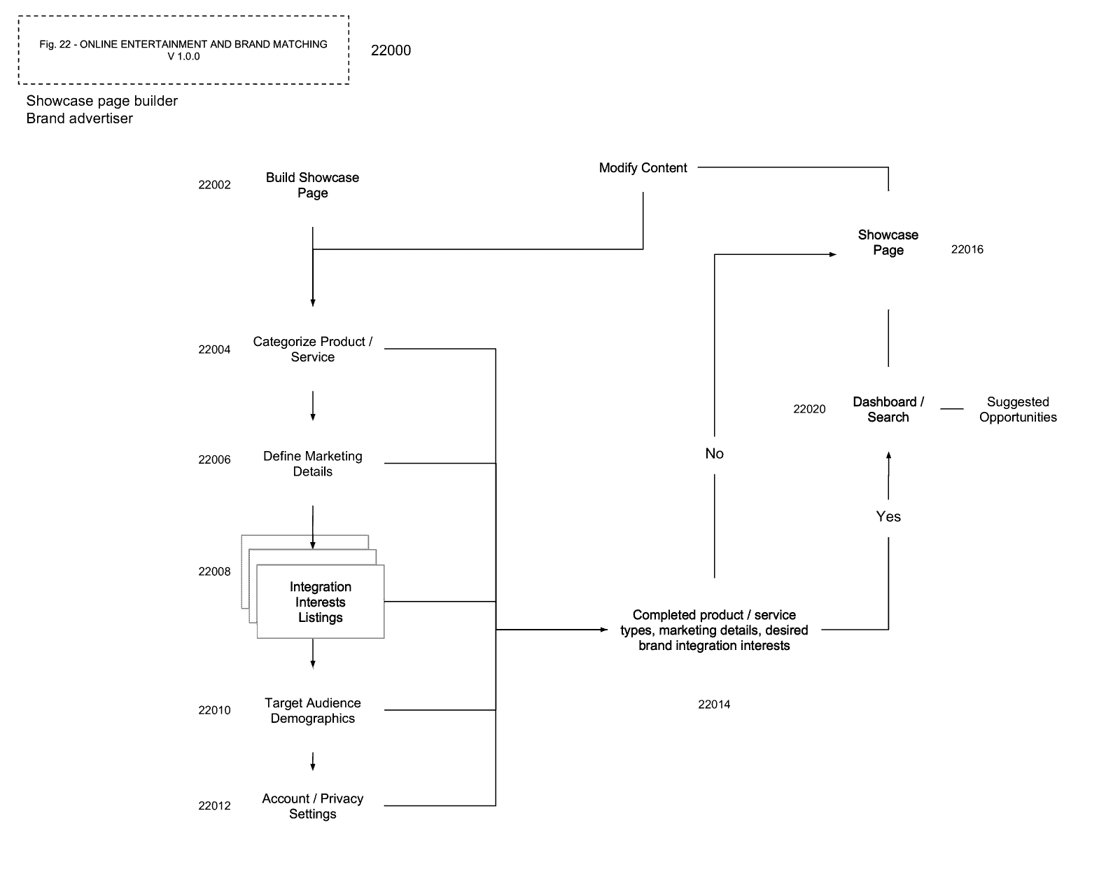

FIG. 22 shows an example embodiment of a showcase page builder flow for a brand advertiser 22000 in accordance with the present invention. In the example embodiment, a system may prompt a user to build a showcase page using fields, buttons, lists, typing, and other methods of data entry and page building in step 22002. Next, the system may prompt a user to respond to a general categorization of product/service types, in step 22004. Next the system may prompt a user to respond to certain marketing details in step 22006. Next the system may prompt the user to create listings of brand integration interests, wants, needs, requirements and other items, in step 22008. Next the system may prompt a user to define their target audience/market demographic details in step 22010.

After a set amount of steps 22002 to 22010, a brand advertiser may skip to the dashboard or a search step 22020. Also, it should be understood that many entry fields could be completed in varying orders, some may be skipped and returned to at later points, and some may be omitted completely, while moving on to others in various embodiments of the invention. Additionally, some entry fields may incorporate results, or single or multiple answers, from previously completed entry fields in generating new results as appropriate, in order to save brand advertisers' time and energy from having to repeatedly answer similar or identical questions.

After completing step 22010, the system may prompt the brand advertiser to select certain account and/or privacy settings at step 22012. Upon completion, the system may determine whether the brand advertiser has completed the categorization of product/service types, preliminary marketing details, and desired brand integration interests, in step 22014. If the brand advertiser has not completed these sections, then the system may provide the brand advertiser with the opportunity to return and complete the incomplete sections. If the brand advertiser has completed the sections as determined in step 22014, then the brand advertiser may be prompted to determine if they wish to view their showcase page 22016 or proceed to the dashboard and search step 22020.

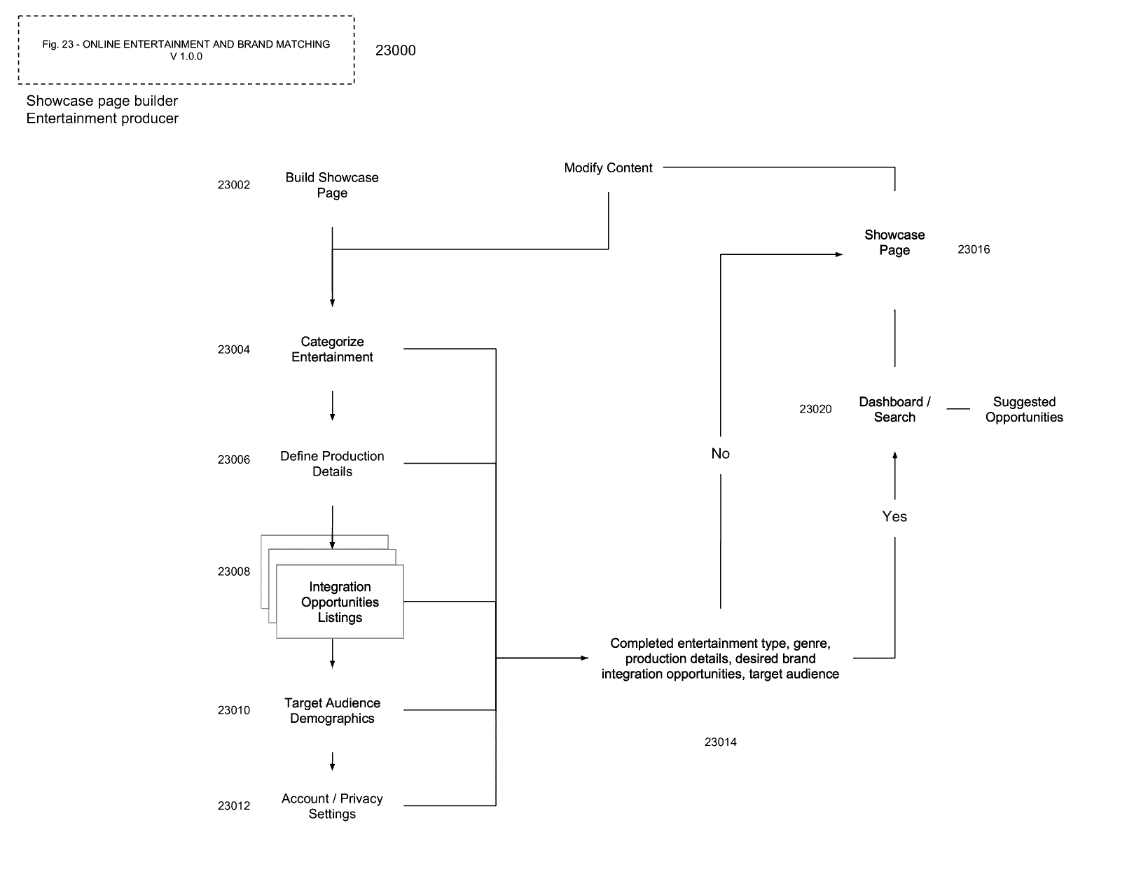

FIG. 23 shows an example embodiment of a showcase page builder flow for an entertainment producer 23000 in accordance with the present invention. In the example embodiment, a system may prompt a user to build a showcase page using fields, buttons, lists, typing, and other methods of data entry and page building, in step 23002. Next, the system may prompt a user to respond to a general categorization of the type of entertainment such as: movie, television, music, video game, social media or other, in step 23004. Next, the system may prompt a user to respond to certain production details or certain categorizations of the entertainment step 23006. Next, the system may prompt the user to create listings of brand integration opportunities, wants, needs, requirements and other items, in step 23008. Next, the system may prompt a user to define their target audience/market demographic details, in step 23010. After a set number of steps, 23002 to 23010, a brand advertiser may skip to the dashboard or a search step 23020. Also, it should be understood that many entry fields could be completed in varying orders, some may be skipped and returned to at later points, and some may be omitted completely while moving on to others in various embodiments of the invention. Additionally, some entry fields may incorporate results, or single or multiple answers, from previously completed entry fields in generating new results as appropriate in order to save entertainment producers' time and energy from having to repeatedly answer similar or identical questions.

After completing step 23010, the system may prompt the entertainment producer to select certain account and/or privacy settings, at step 23012. Upon completion, the system may determine whether the entertainment producer has completed the categorization of entertainment type and genre, preliminary production details, and desired brand integration opportunities, in step 23014. If the entertainment producer has not completed these sections, then the system may provide the entertainment producer with the opportunity to return and complete the incomplete sections. If the entertainment producer has completed the sections as determined in step 23014, then the entertainment producer may be prompted to determine if they wish to view their showcase page or proceed to the dashboard and search step 23020.

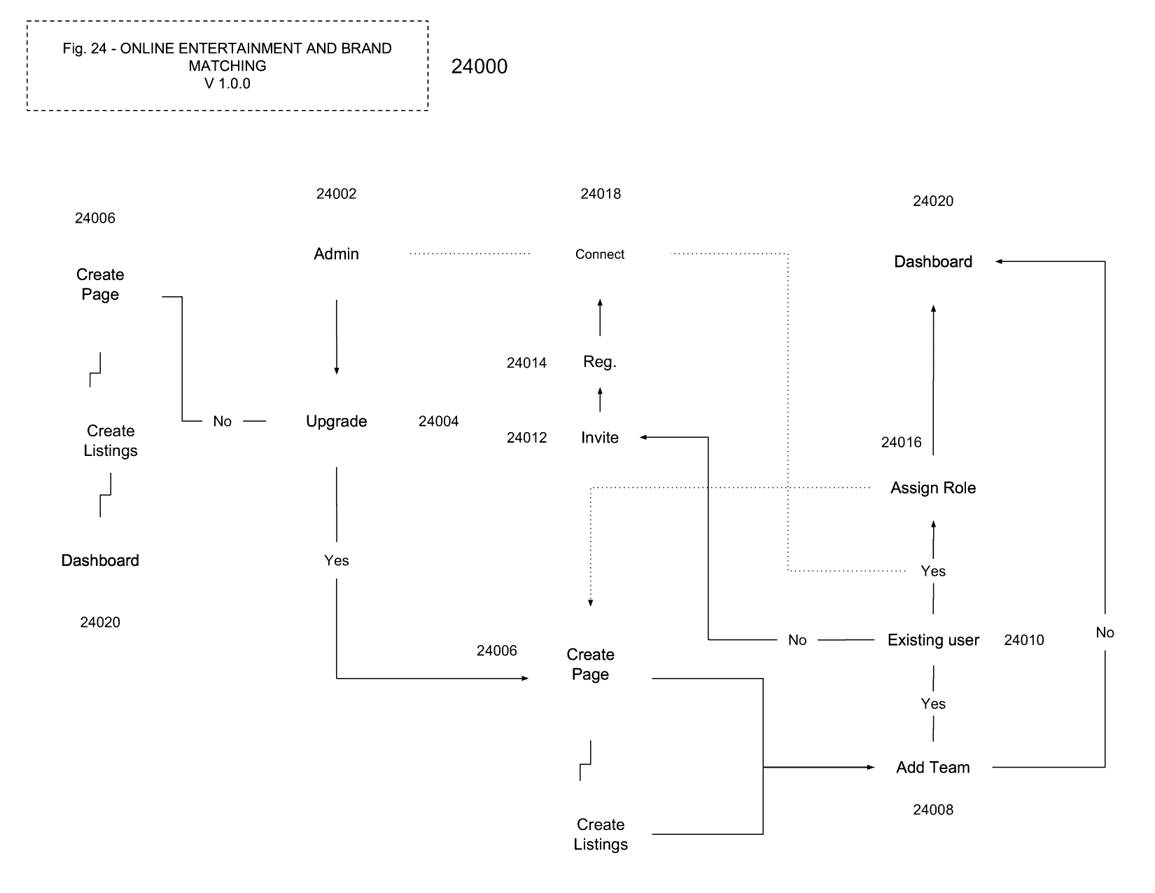

FIG. 24 shows an example embodiment in which the entertainment producer or brand advertiser who initially created the account (also known as “Admin”) 24002 may choose whether to upgrade the account 24004. Once the account type is established (a subscription account type may be altered at any time), then the user may create showcase page(s) or listings in step 24006 before proceeding to the dashboard 24020. Depending on the level of upgrade, the admin user may then determine whether to add an associated representative/agent or manager “Team” to the listing or showcase page in step 24008.

The added managing team member may be the individual who created the showcase page or listing in step 24006 or it may be a different individual or group of individuals associated with the entertainment production/brand advertiser. In embodiments where a representative/agent or manager has been previously registered with the system, the system may perform a step 24018 to link the previously added representative/agent or manager with the admin.

In embodiments where the representative/agent or manager has not been previously added to the system, the system may move to step 24012 and add a new representative/agent or manager via an email address. In adding the new representative/agent or manager via an email address, the system may determine that the representative/agent or manager has not previously been a system user, in step 24010. In this case the system may send a registration email to the representative/agent or manager in step 24012. This email sending leads to the system starting a user registration in step 24014.

In some embodiments, the system may determine that the representative/agent or manager is already a system user and prompt the admin user to assign a ‘Role’ to the team member(s), in step 24016. In these embodiments the system will connect the team member and the admin member to one another in step 24018.

Once the admin connects with a team member, they will have the option to add the representative/agent or manager to an integration listing or showcase page. This may occur in a dialog box. The admin will have the option to select a representative/agent or manager from a list of previously added team members (if available), or add a new representative/agent or manager. When adding a new representative/agent or manager, the admin will need to provide the representative/agent or manager's email to see whether they already have a user account saved in the system. If the representative/agent or manager is already a user, the account admin may link the representative/agent or manager's email to the showcase page or listing. If the representative/agent or manager does not have a user account, a registration email will be sent out to the representative/agent or manager's email.

The representative/agent or manager will have to go through the user registration process. The representative/agent or manager's details may already be pre-populated (e.g., name, and email), and the representative/agent or manager may have a status of a pre-registered user. The representative/agent or manager may have to select a valid password in order to register or choose to register through a third party API. If the representative/agent or manager registers through a web-form email, no validation may be required. Once registered, the representative/agent or manager may go through the same flow as an entertainment production admin.

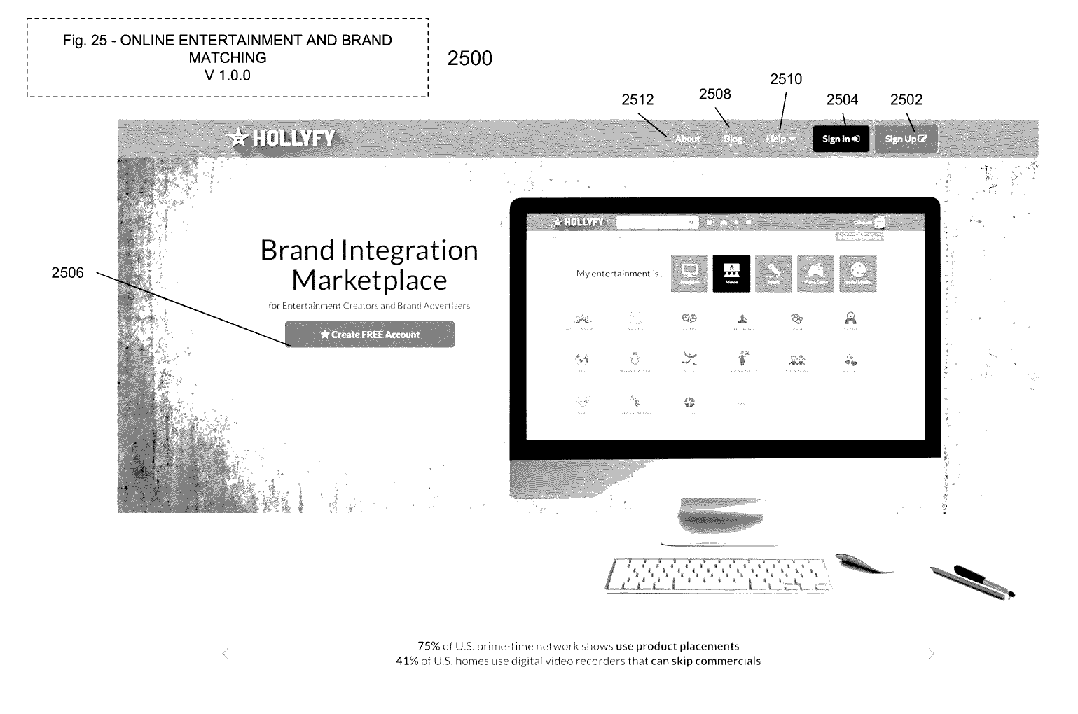

FIG. 25 shows an exemplary user homepage 2500 according to an embodiment of the present invention. In the exemplary embodiment, the user may select a sign-up button 2502 which may take them to a registration page. The user may select a sign in button 2504 which may take the user to a login page. The user may select a “Create Account” button 2506, which may take a user to a membership page. The user may select a blog button 2508 thereby taking the user to a blog page. The user may select a help center button 2510 thereby taking the user to a contact information page. The user may select an “about us” button 2512, which may take the user to a system administrator description page.

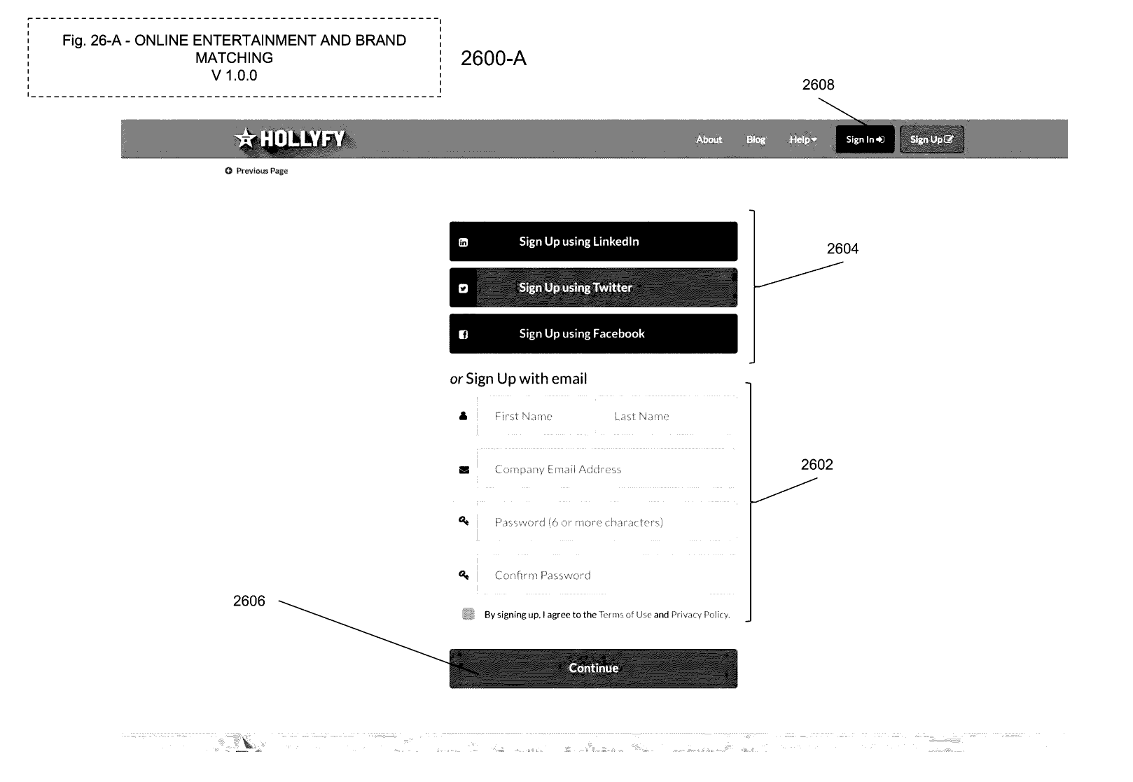

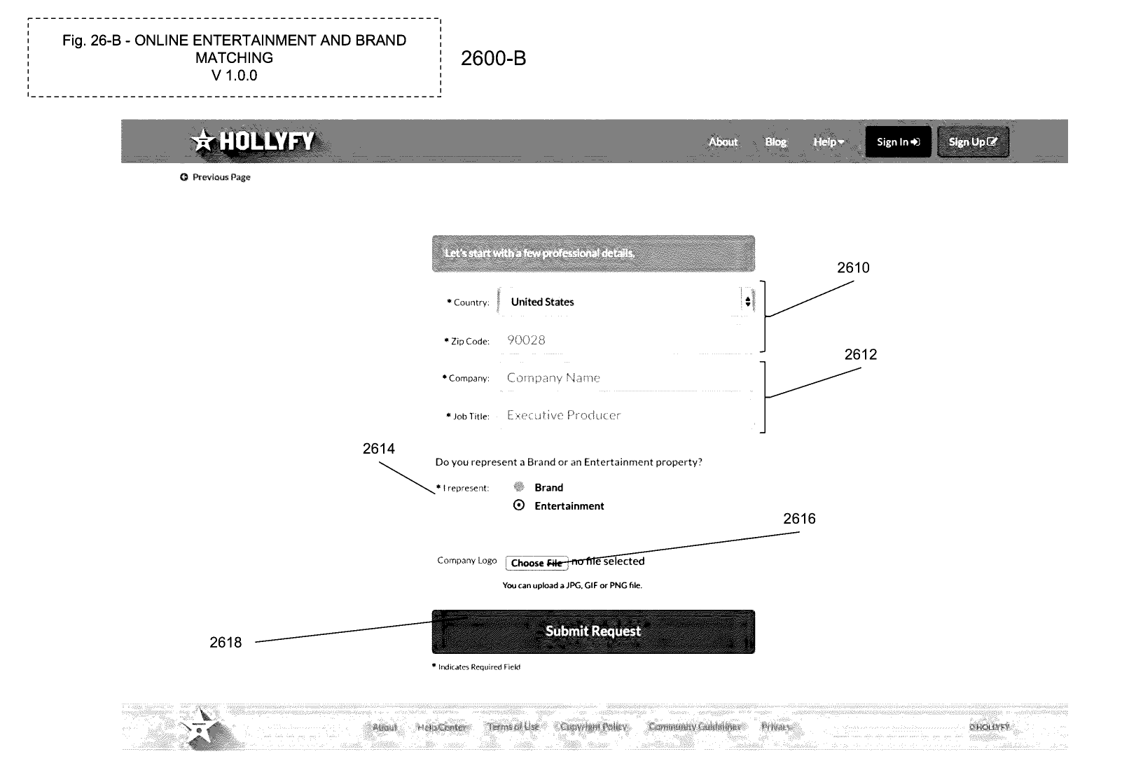

FIG. 26 shows an exemplary user registration page 2600, according to an embodiment of the present invention. In the example embodiment, a web form registration field 2602 allows a user to register via email. Also provided are third party API registration links 2604 to sign in with profiles established in other systems such as social media. A “continue” button 2606 transitions a user to next step, shown in FIG. 26-B, and a sign-in button 2608 may take a user to a login page.

FIG. 26-B shows a second step user registration page 2600-B according to an embodiment of the present invention. In the example embodiment a web form registration field 2610 allows a user to register a geo location. Also provided is a web form registration field 2612 to designate the official company and title of the user. Users may also designate their accounts as either brand or entertainment 2614 using another selection field. Users may elect to upload an image in step 2616, and a submit button 2618 may allow a user to proceed with the registration process.

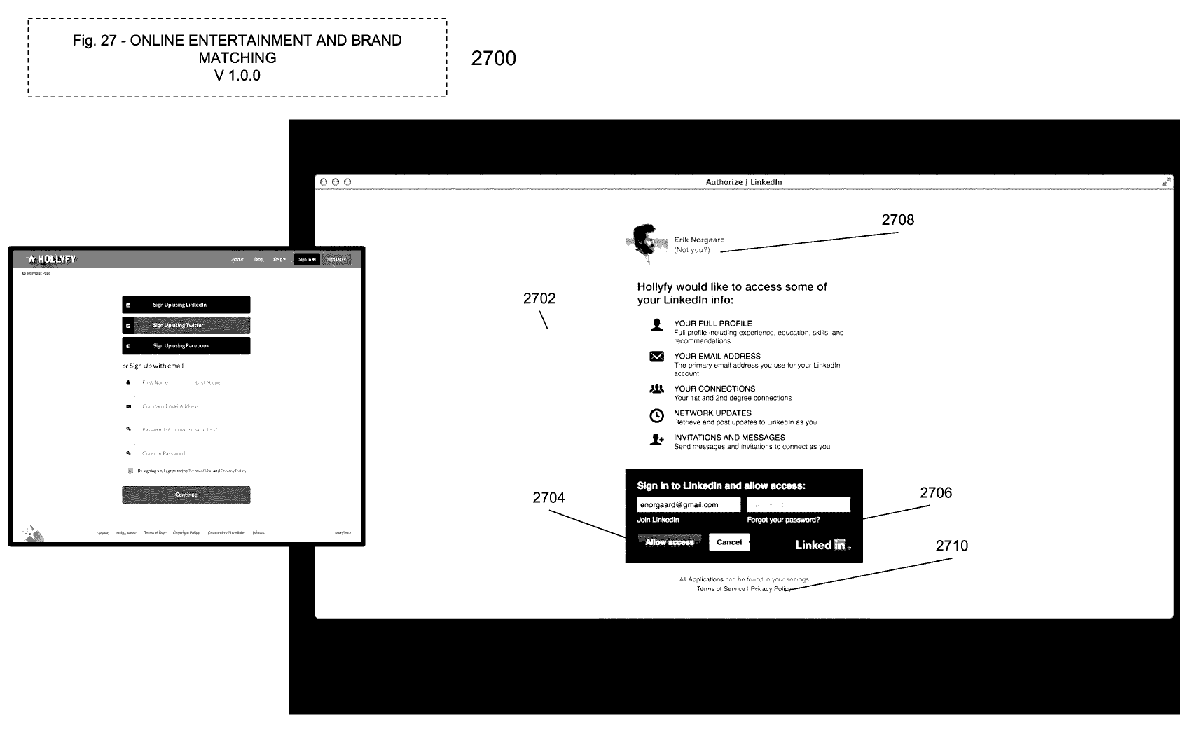

FIG. 27 is a diagram showing a user registration page 2700 using a third party system, such as a social media platform, according to an embodiment of the present invention. In the example embodiment, the system allows users to provide third party system credentials 2702 such as LinkedIn credentials, and a user email is pre-populated when a user is already signed in to a third party system. An “allow access” button 2704 registers the user and stores the permissions. A cancel button 2706 takes the user back to a registration page. A “not you?” button 2708 takes users to the screen at the left of FIG. 27 where no credentials have been pre-populated. Terms of Service and Privacy Policy buttons 2710 open the system's terms of service and privacy policy pages respectively. In some embodiments, these may be opened in new windows.

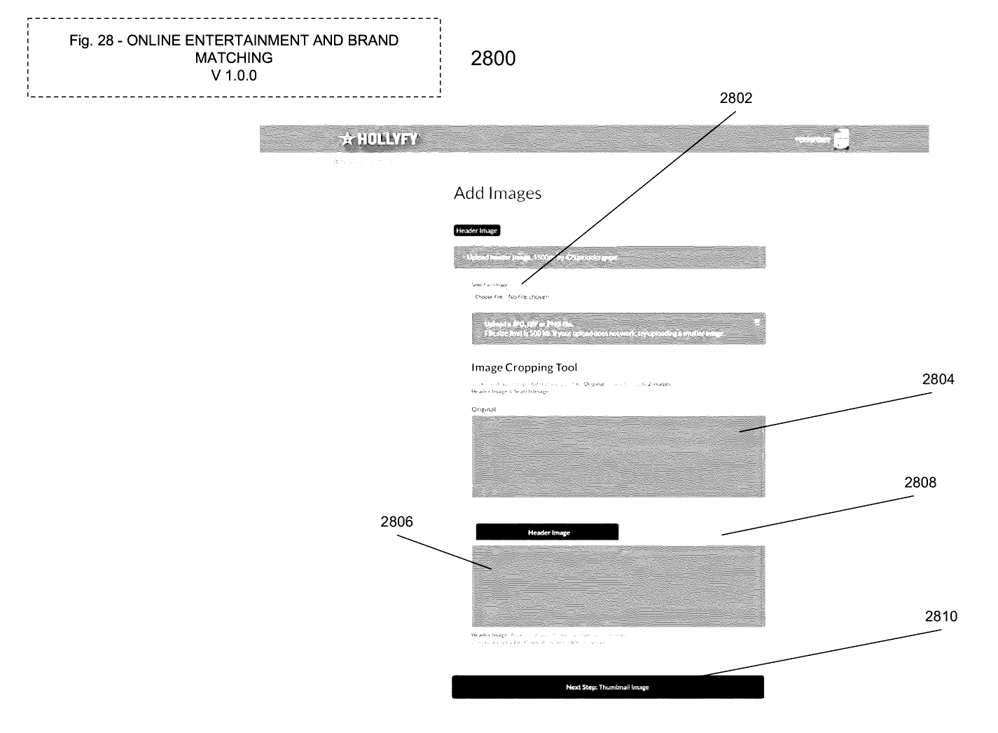

FIG. 28 shows a user image upload and editing page for a header/search image 2800 according to an embodiment of the present invention. In the example embodiment, a computer upload button 2802 allows a user to select an image file to upload for display on a brand advertiser/entertainment producer showcase page. A crop area 2804 may allow a user to move a cropping tool anywhere within image borders and expand or minimize the area within minimum and maximum limits. Whatever is shown in crop area 2806 may be displayed as the user's header image and whatever is shown in crop area 2808 may be displayed as the user's search image. A “next step” button 2810 saves the image(s), and permits the user to proceed.

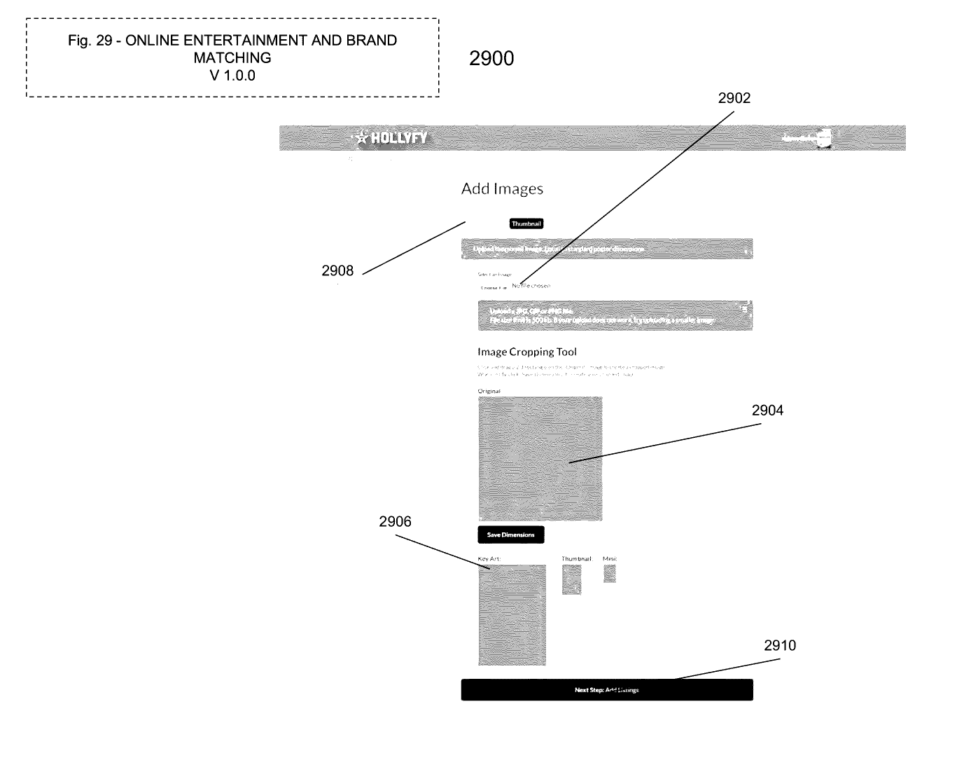

FIG. 29 shows a user image upload and editing page for a thumbnail image 2900 according to an embodiment of the present invention. In the example embodiment, a computer upload button 2902 allows a user to select an image file to upload and display on a brand advertiser/entertainment producer showcase page. A crop area 2904 may allow a user to move a cropping tool anywhere within image borders and expand or minimize the area within minimum and maximum limits. Whatever is shown in crop area 2906 may be displayed as the user's key art, thumbnail, and mini image. A header image button 2908 allows the user to review or modify the header/search image in FIG. 28. A “next step” button 2910 saves the image, and permits the user to proceed.

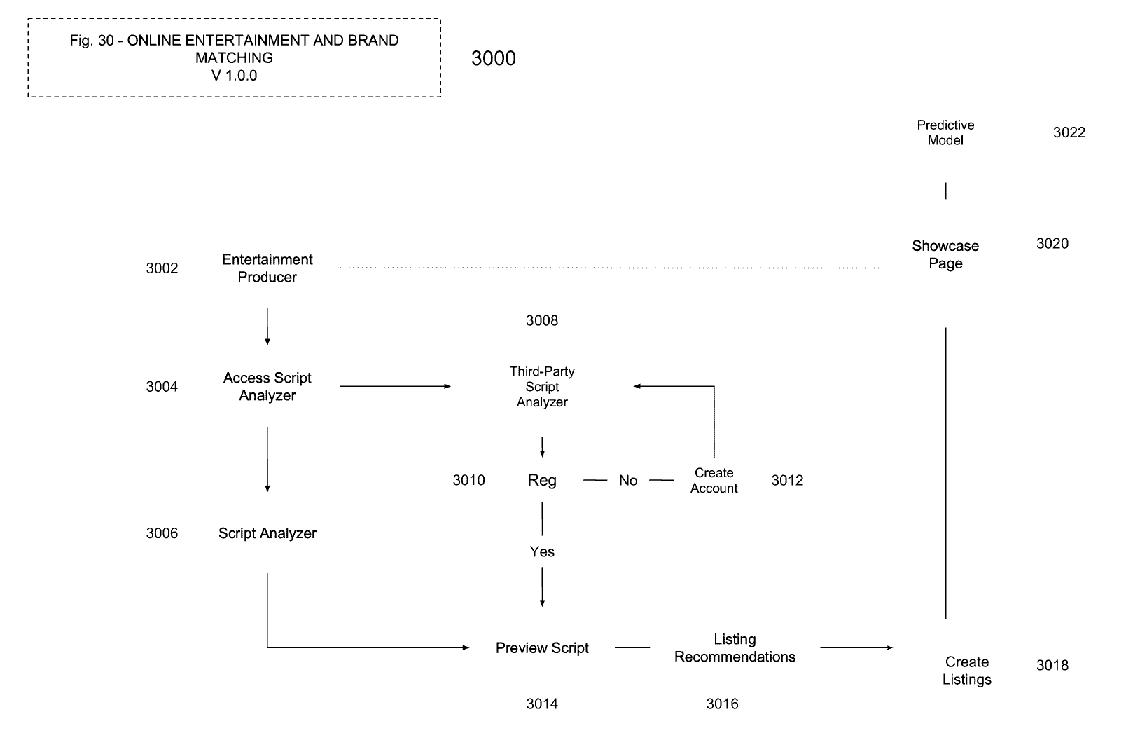

FIG. 30 is a diagram showing an entertainment production script upload process 3000 according to an embodiment of the present invention. An entertainment producer 3002, depending on membership factors, may utilize a script analyzer feature 3004. This process may occur during registration, during the on-boarding process or at other locations on the website. This may also utilize script analyzer 3006 or another third party website script analyzer 3008 which may allow an entertainment producer to upload a script via a third party website. If the entertainment producer has not registered via the third party website, they may be directed to create an account 3012, and proceed with an authentication process that occurred during the registration. If the entertainment producer registered via a specific third party website page 3010, it may state the name of the third party website where the script is located. In either instance, once a script is uploaded, a user may continue to a script preview page 3014. A script upload button allows an entertainment producer to select a file to upload before continuing to a script preview page 3014. A continue later button allows an entertainment producer to move forward in the process, and upload a script at a later point. Once the entertainment producer has reviewed the preview page they may continue with automated recommendations 3016, save for later, cancel or continue to another permitted section. If the user chooses to utilize the automated recommendations feature, the system will display new listings 3018 connected to the entertainment production's showcase page 3020. If the user chooses to accept this brand integration , this input data may be incorporated into the automated suggested opportunities predictive model 3022.

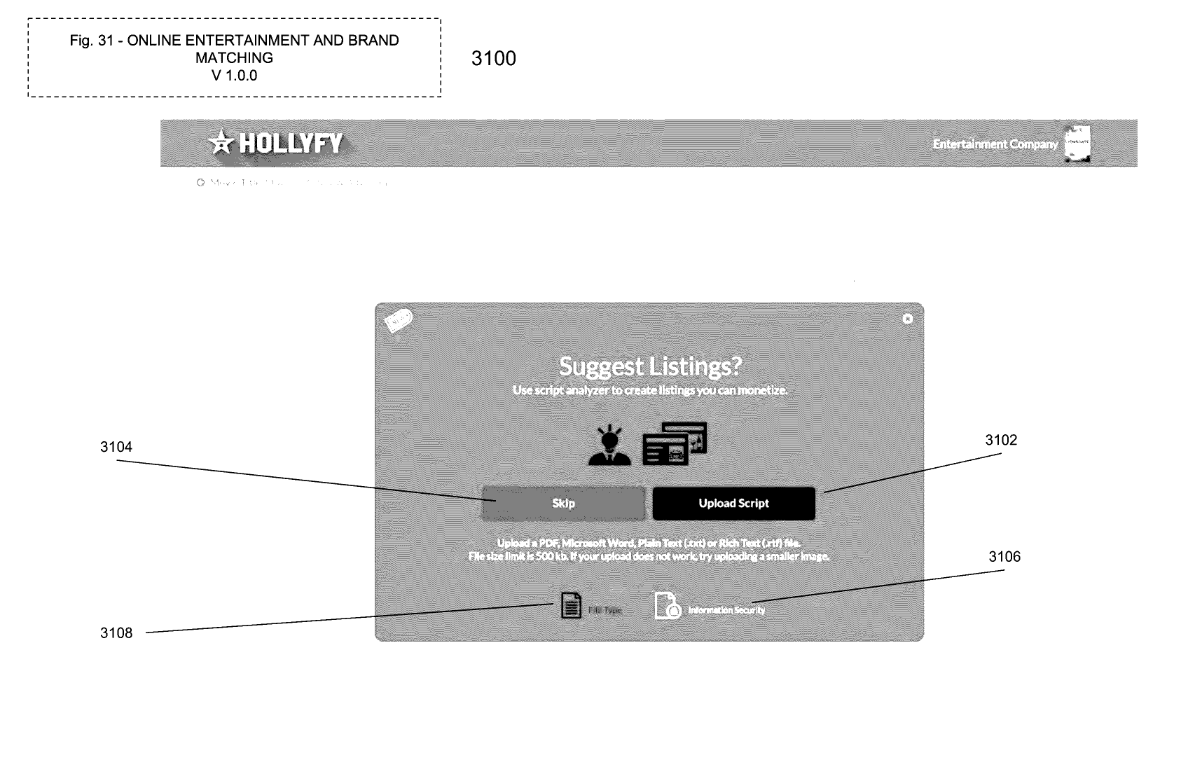

FIG. 31 shows an example of an entertainment production script analyzer prompt page 3100 according to an embodiment of the present invention. An ‘Upload Script’ button 3102 takes an entertainment producer to the next step in the script analyzer. A skip button 3104 allows an entertainment producer to skip to manually enter data to create a brand integration listing opportunity. A file type button 3106 helps the user understand compatible file types for recognition. An information security button 3106 informs the user of safety protocol systems, the possible uses of the script, and other privacy details.

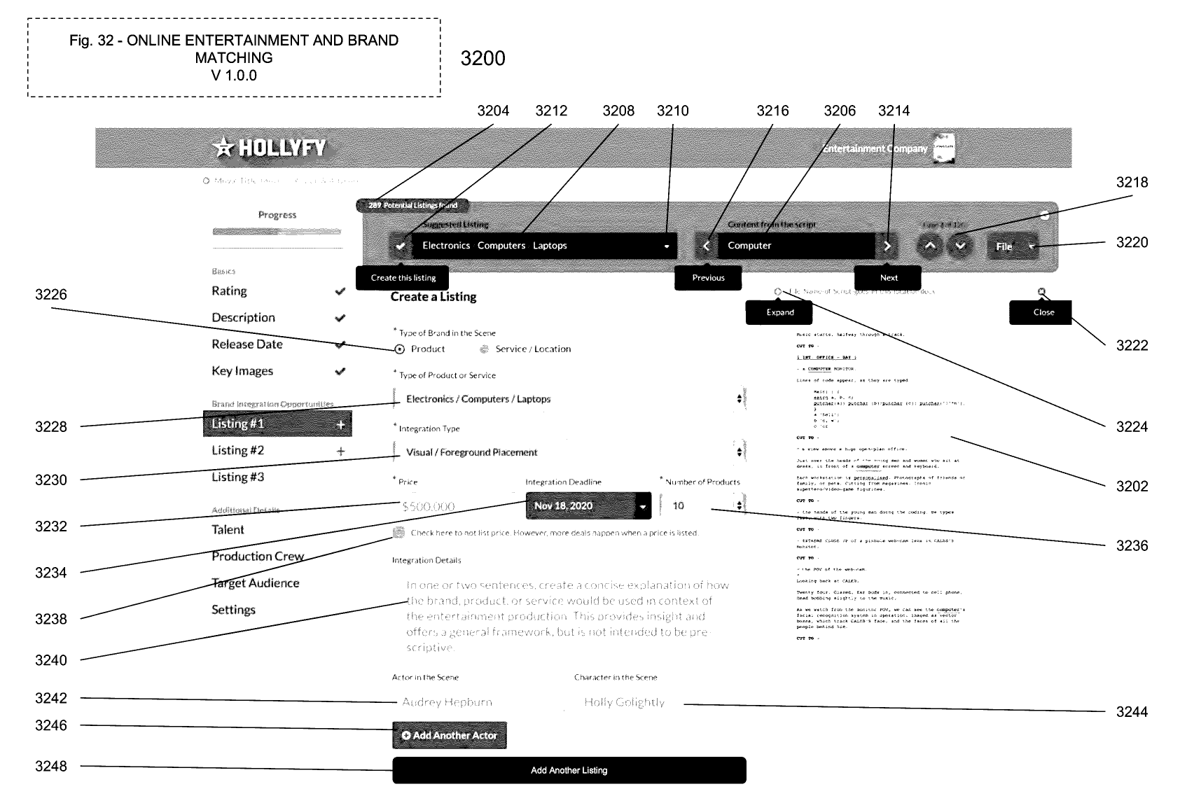

FIG. 32 shows an exemplary secondary entertainment production script recommendations page 3200 according to an embodiment of the present invention. A display of the text file 3202 reveals the current page in the file that has been uploaded and analyzed. An approximate number of total potential brand integration listings are shown in 3204. Content in the provided file is analyzed and displayed in a text field 3206. The analyzed content 3206 from the provided file 3202 may be applied to a matching algorithm, connected with a database and/or autofill a ‘suggested listing’ 3208, which may be further refined based on specific needs using a dropdown menu 3210 and/or by manually entering text data. Once the listing is suitable for the entertainment producer's needs, a ‘Create this Listing’ or checkmark button 3212, autofills data below. The user may choose to view another piece of content from the file using the next button 3214, or may view a previous piece of content using the previous button 3216. The user may choose another page using the forward or backward buttons 3218. The user may upload another file, or select other menu options, in a dropdown menu 3220. The user may close their file 3222, or expand 3224 a view of their file to better read and understand the context of its use, purpose, needs or other relevant details.

In the “Create a Listing section” of FIG. 32, other details may autofill and can further be refined. Information includes but is not limited to the type of brand in the scene (product or service) 3226, category of product or service 3228, integration type 3230, approximate price 3232, integration deadline 3234, number of products requested 3236, whether the entertainment producer decides to show a price or not 3238, additional details of the integration 3240, the name of an actor or actress in the scene 3242, the name of a character in the scene 3244, add another actor 3246, and other useful fields of information. An add another listing button 3204 performs an autosave, and segues to the next piece of content in the provided file. If the current section is the last section of the script analyzer, this button may take the entertainment production to a listing review page.

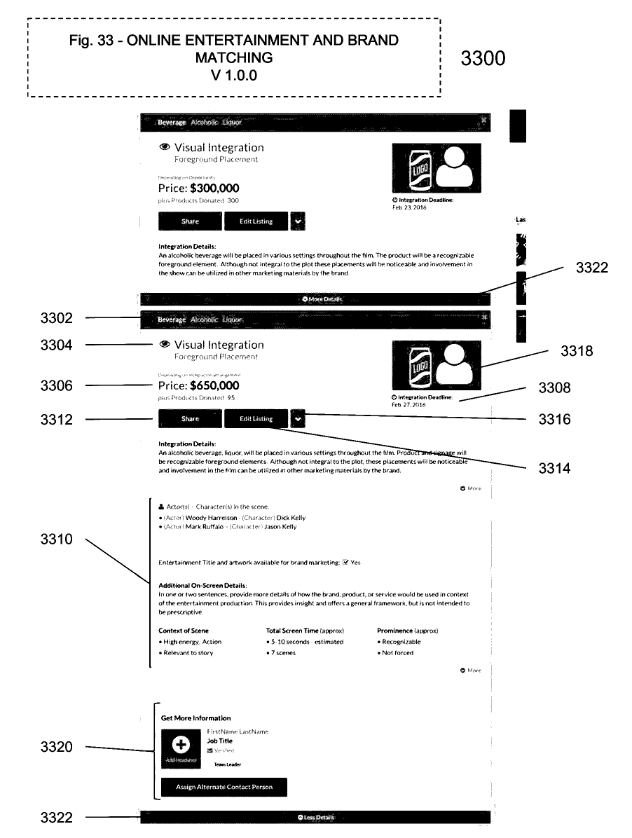

FIG. 33 shows an exemplary entertainment production integration listing review page 3300, according to an embodiment of the present invention. In the example embodiment, the type of product or service which was either manually created, created using automated features similar to the script analyzer and recommendation page, or by other tools, is displayed in 3302. Listings created may show relevant details which may be accessed by a learning algorithm, a matching algorithm, a ranking algorithm, a database or integrate with other sections of the website. These attributes include but are not limited to the type of product or service 3302, type of integration 3304, price 3306, integration deadline 3308, and other relevant details 3310. The listing may be shared with members, on a newsfeed, on additional social channels or in other digital outlets 3312. The account holder or manager of the listing may edit the content 3314 or access other relevant tools 3316. A visual representation may show a graphic image of the type of integration 3318. Details of a contact person associated with or managing the listing may be added or edited 3230. Additionally, more or less information may be shown by toggling a divider-bar 3322.

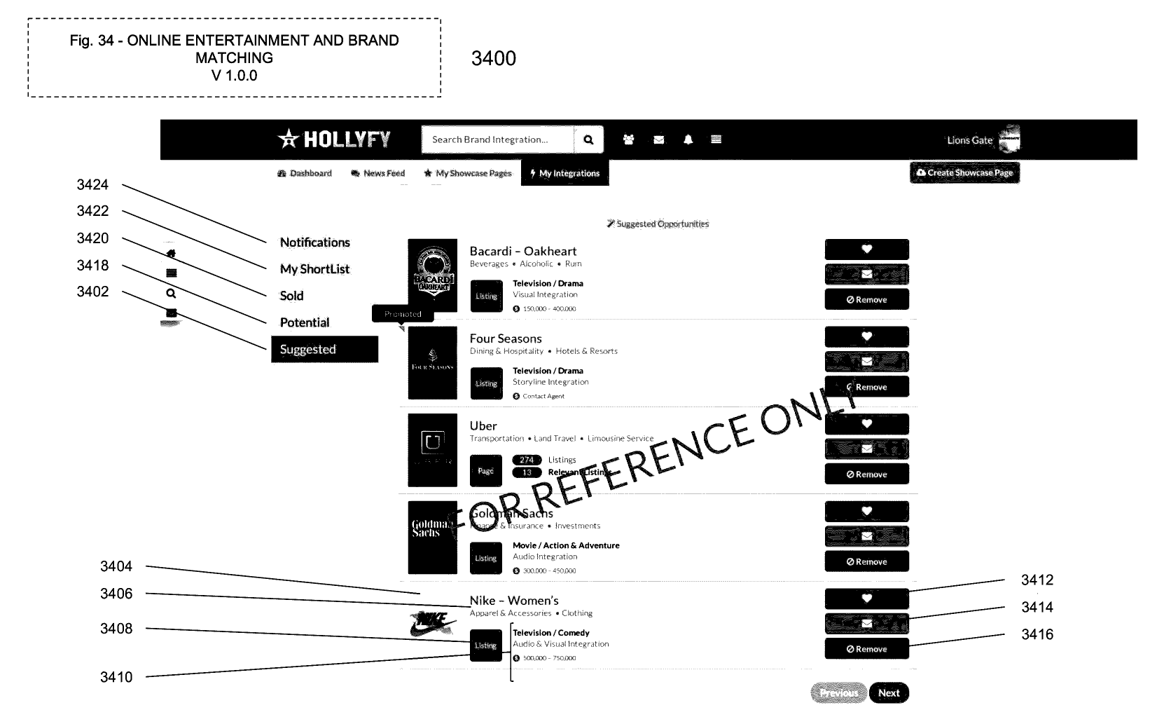

FIG. 34 shows an exemplary entertainment production suggested matches page 3400, according to an embodiment of the present invention. In the example embodiment, suggested matches 3402 may be made visible to the user based on a correlation of data points and algorithmic matching and ranking models. Relevant data points may be shown t o the user, including a visual representation 3404 of the matched member as well as; username, brand name, type of product/service 3406, or in some cases similar data points about entertainment members which could also match certain listings, showcase page data or other relevant details. Additional details about the suggested match may include whether the match is a singular listing by a member or multiple listing on a member's showcase page 3408, and may include several other data points 3410 including, but not limited to, other member's interest in type of entertainment, type of integration, budget/price or other relevant details.

A user may choose to shortlist the suggested opportunity for later review 3412, message the user 3414, or remove the suggested match 3416.

Additional tools to manage brand integrations according to an embodiment of the present invention may include potential integrations 3418, sold listings 3420, shortlisted content 3422, or other relevant notifications 3424.

Similar suggested matches and other features may be shown to brand advertisers, and the corresponding brand integration matches which they may have with entertainment producers or other brands.

These suggested matches may be found in other locations on the website, in emails, in mobile notifications, API connections, databases, or other areas.

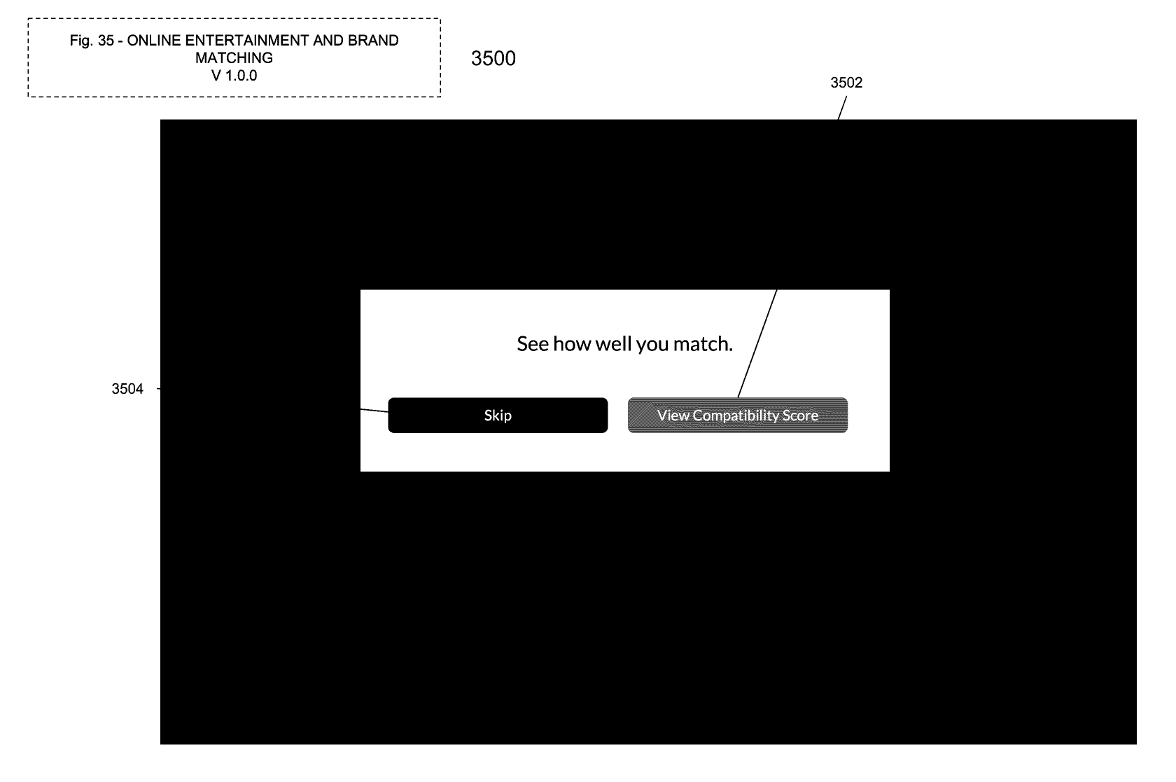

FIG. 35 shows a brand advertiser/entertainment producer compatibility scorecard prompt page 3500 according to an embodiment of the present invention. A view compatibility score button 3502 allows a user to view a compatibility scorecard if the users have previously completed a showcase page and integration listings. When the user selects this button it will take them to the first page of the scorecard. A skip button 3504 may take the user to their dashboard, to update necessary content sections or another area of the website.

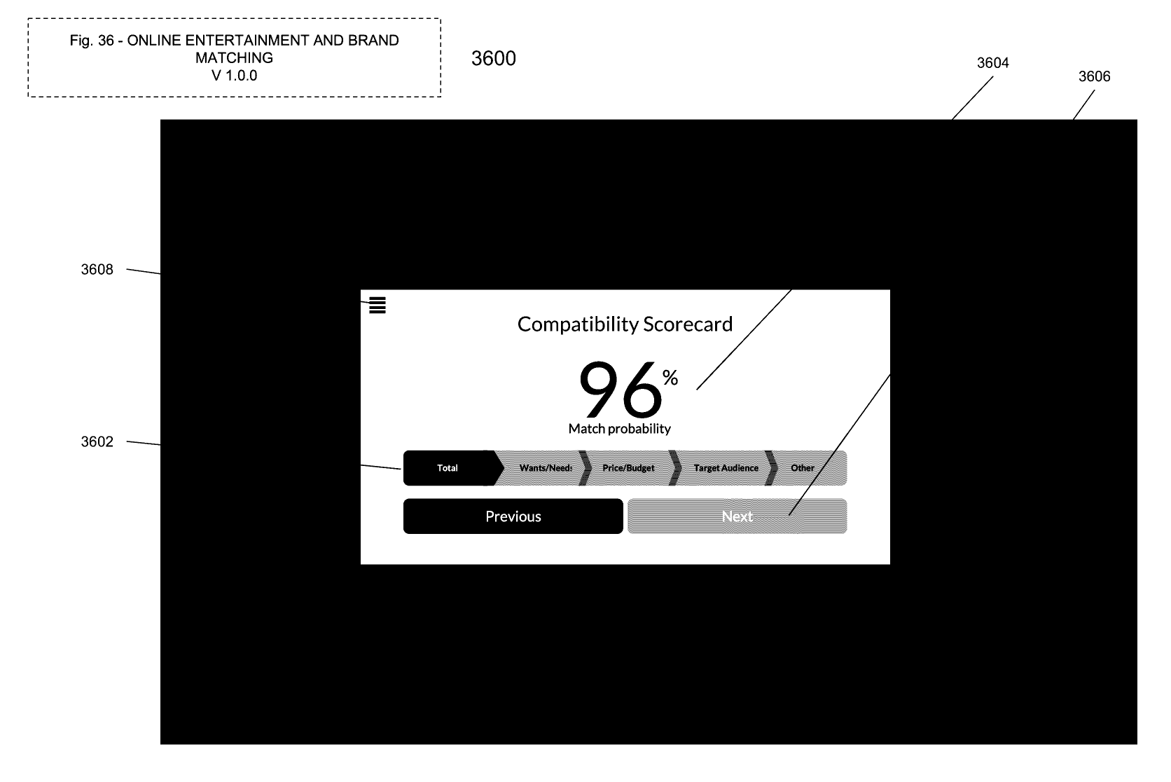

FIG. 36 is a diagram showing a brand advertiser/entertainment producer compatibility scorecard 3600 according to an embodiment of the present invention. Match probability may be shown in totality or according to other statistical data points 3602 such as wants/needs, price/budget, target audience or other relevant sources of information. This data may be extracted and suggested as a numerical reference 3604. A next button 3606 may take a user to a next page of the compatibility scorecard. If the current page is the last page then the user may be taken to suggested automated search results. A collapsed menu 3708 may contain listing details, showcase page details, profile details, messages, and/or other relevant sections. If a user selects any of the sections, the user will be taken to the corresponding page.

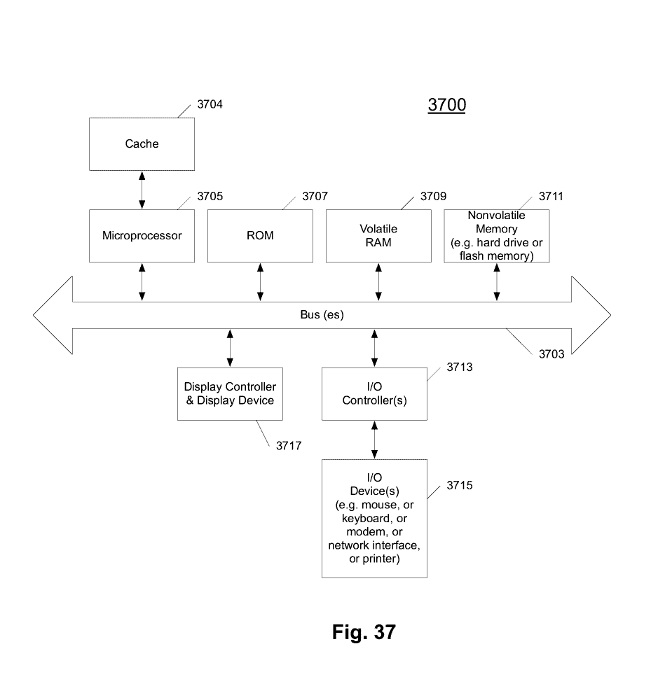

FIG. 37 shows one example of a data processing system 3700, which may be used with one embodiment of the present invention. For example, the system 3700 may be implemented including devices 110, 120, 130, 140, and/or 150 as shown in FIG. 1. Note that while FIG. 37 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 37, the computer system 3700, which is a form of a data processing system, includes a bus 3703 which is coupled to a microprocessor(s) 3705 and a ROM (Read Only Memory) 3707 and volatile RAM 3709 and a non-volatile memory 3711. The microprocessor 3705 may include one or more CPU(s), GPU(s), a specialized processor, and/or a combination thereof. The microprocessor 3705 may retrieve the instructions from the memories 3707, 3709, 3711 and execute the instructions to perform operations described above. The bus 3703 interconnects these various components together and also interconnects these components 3705, 3707, 3709, and 3711 to a display controller and display device 3717 and to peripheral devices such as input/output (I/O) devices which may be mice, keyboards, modems, network interfaces, printers and other devices which are well known in the art. Typically, the input/output devices 3715 are coupled to the system through input/output controllers 3713. The volatile RAM (Random Access Memory) 3709 is typically implemented as dynamic RAM (DRAM), which requires power continually in order to refresh or maintain the data in the memory.

The mass storage 3711 is typically a magnetic hard drive or a magnetic optical drive or an optical drive or a DVD RAM or a flash memory or other types of memory systems, which maintain data (e.g. large amounts of data) even after power is removed from the system. Typically, the mass storage 3711 will also be a random access memory although this is not required. While FIG. 37 shows that the mass storage 3711 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 3703 may include one or more buses connected to each other through various bridges, controllers and/or adapters as is well known in the art.

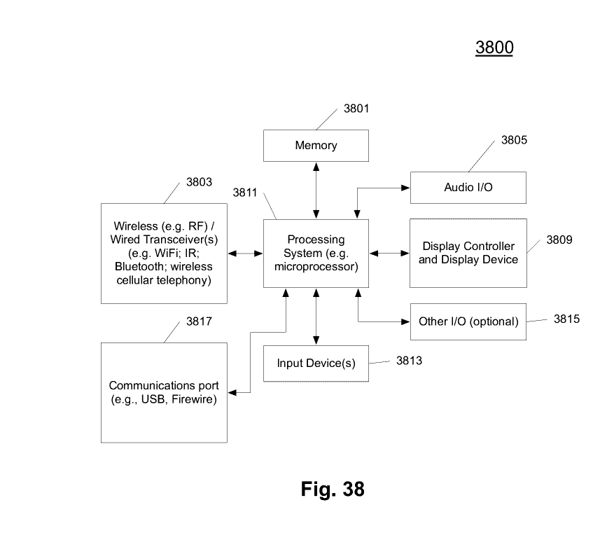

FIG. 38 shows an example of another data processing system 3800 which may be used with one embodiment of the present invention. For example, system 3800 may be implemented as devices 110, 120, 130, 140, and/or 150 as shown in FIG. 1. The data processing system 3800 shown in FIG. 38 includes a processing system 3811, which may be one or more microprocessors, or which may be a system on a chip integrated circuit, and the system also includes memory 3801 for storing data and programs for execution by the processing system. The system 3800 also includes an audio input/output subsystem 3805, which may include a microphone and a speaker for, for example, playing back music or providing telephone functionality through the speaker and microphone.

A display controller and display device 3809 provide a visual user interface for the user; this digital interface may include a graphical user interface which is similar to that shown on a Macintosh computer when running OS X operating system software, or Apple iPhone when running the iOS operating system, etc. The system 3800 also includes one or more wireless transceivers 3803 to communicate with another data processing system, such as the system 3800 of FIG. 38. A wireless transceiver may be a WLAN transceiver, an infrared transceiver, a Bluetooth transceiver, and/or a wireless cellular telephony transceiver. It will be appreciated that additional components, not shown, may also be part of the system 3800 in certain embodiments, and in certain embodiments fewer components than shown in FIG. 38 may also be used in a data processing system. The system 3800 further includes one or more communications ports 3817 to communicate with another data processing system. The communications port may be a USB port, Firewire port, Bluetooth interface, etc.

The data processing system 3800 also includes one or more input devices 3813, which are provided to allow a user to provide input to the system. These input devices may be a keypad or a keyboard or a touch panel or a multi touch panel. The data processing system 3800 also includes an optional input/output device 3815 which may be a connector for a dock. It will be appreciated that one or more buses, not shown, may be used to interconnect the various components as is well known in the art. The data processing system shown in FIG. 38 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 3800 may be a network computer or an embedded processing device within another device, or other types of data processing systems, which have fewer components or perhaps more components than that shown in FIG. 38.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “retrieving,” “selecting,” “receiving,” “determining,” “computing,” “compressing,” “changing,” “storing,” “sampling,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer-based system for presenting brand integration analysis, comprising:
an entertainment and brand matching server system, coupled to a public network, wherein the entertainment and brand matching server system is configured to:
receive and store a brand advertiser or entertainment productions data in memory,
generate a showcase page and integration listings,
receive and store data about brand advertiser or entertainment production,
generate team profiles for specific users,
generate listings for brand advertisers or entertainment productions;
calculate a plurality of matching probability values by correlating the brand advertiser content with the specific entertainment production's content; use the plurality of matching probability values to create matches between integration listings and correlated users if an overall matching probability value meets or exceeds a predetermined threshold,
calculate a generalized matching probability value by correlating the brand advertiser content with the data of generalized types of entertainment productions, such correlation resulting in a potential match if the matching probability value meets or exceeds a predetermined threshold,
using calculated matching probability values generated from correlation of brand advertiser content with the content of generalized types of entertainment productions to create matches between integration listings and correlated users if the compatibility value meets or exceeds a predetermined threshold,
presenting data associated with the specific entertainment production's showcase page or listing to the brand advertiser based on one or more of the matching probability values, when a brand advertiser search result or match is generated,
presenting the data associated with the generalized entertainment and production's showcase page or listing to the brand advertiser based on one or more of the matching probability values, when an entertainment production search result or match is generated; and
at least one user interface device, connected to the public network, wherein the user interface device is configured to enable a user to evaluate the matching probability in a search result or match.

2. The computer-based system of claim 1, wherein enabling the brand advertiser and the entertainment production to evaluate the potential match includes presenting matching probability attributes.

3. The computer-based system of claim 2, wherein presenting matching probability attributes includes displaying matching probability visualizations.

4. The computer-based system of claim 2, wherein presenting matching probability attributes includes displaying a dynamic matching probability indicator.

5. The computer-based system of claim 2, wherein presenting matching probability attributes includes displaying a relative component importance map.

6. The computer-based system of claim 2, wherein presenting matching probability attributes includes displaying icons and summaries using color coordination.

7. The computer-based system of claim 1, wherein a brand advertiser may search for an entertainment production based on one or more attributes.

8. The computer-based system of claim 1, wherein an entertainment production may search for a brand advertiser based on one or more attributes.

9. A method for determining brand integration analysis matches, the method comprising:
receiving and storing a brand advertiser or entertainment productions data in memory;
generating a showcase page and integration listings;
receiving and storing data about brand advertiser or entertainment production;
generating team profiles for specific users;
generating listings for brand advertisers or entertainment productions;
calculating a plurality of matching probability values by correlating the brand advertiser content with the specific entertainment production's content;
using the plurality of matching probability values to create matches between integration listings and correlated users if an overall matching probability value meets or exceeds a predetermined threshold;
calculating a generalized matching probability value by correlating the brand advertiser content with the data of generalized types of entertainment productions, such correlation resulting in a potential match if the matching probability value meets or exceeds a predetermined threshold;
using calculated matching probability values generated from correlation of brand advertiser content with the content of generalized types of entertainment productions to create matches between integration listings and correlated users if the compatibility value meets or exceeds a predetermined threshold;
presenting data associated with the specific entertainment production's showcase page or listing to the brand advertiser based on one or more of the matching probability values, when a brand advertiser search result or match is generated; and
presenting the data associated with the generalized entertainment and production's showcase page or listing to the brand advertiser based on one or more of the matching probability values, when an entertainment production search result or match is generated.

10. The method of claim 9, wherein enabling the brand advertiser and the entertainment production to evaluate the potential match includes presenting matching probability attributes.

11. The method of claim 10, wherein presenting matching probability attributes includes displaying matching probability visualizations.

12. The method of claim 10, wherein presenting matching probability attributes includes displaying a dynamic matching probability indicator.

13. A non-transitory machine-readable medium containing executable program instructions which when executed by a data processing device cause the device to perform a method to determine brand integration analysis matches, the method comprising:
receiving and storing a brand advertiser or entertainment productions data in memory;
generating a showcase page and integration listings;
receiving and storing data about brand advertiser or entertainment production;
generating team profiles for specific users;
generating listings for brand advertisers or entertainment productions; calculate a plurality of matching probability values by correlating the brand advertiser content with the specific entertainment production's content;
using the plurality of matching probability values to create matches between integration listings and correlated users if an overall matching probability value meets or exceeds a predetermined threshold;
calculating a generalized matching probability value by correlating the brand advertiser content with the data of generalized types of entertainment productions, such correlation resulting in a potential match if the matching probability value meets or exceeds a predetermined threshold;
using calculated matching probability values generated from correlation of brand advertiser content with the content of generalized types of entertainment productions to create matches between integration listings and correlated users if the compatibility value meets or exceeds a predetermined threshold;
presenting data associated with the specific entertainment production's showcase page or listing to the brand advertiser based on one or more of the matching probability values, when a brand advertiser search result or match is generated; and
presenting the data associated with the generalized entertainment and production's showcase page or listing to the brand advertiser based on one or more of the matching probability values, when an entertainment production search result or match is generated.

14. The machine-readable medium of claim 13, wherein enabling the brand advertiser and the entertainment production to evaluate the potential match includes presenting matching probability attributes.

15. The machine-readable medium of claim 14, wherein presenting matching probability attributes includes displaying matching probability visualizations.

16. The machine-readable medium of claim 14, wherein presenting matching probability attributes includes displaying a dynamic matching probability indicator.

17. The machine-readable medium of claim 14, wherein presenting matching probability attributes includes displaying a relative component importance map.

18. The machine-readable medium of claim 14, wherein presenting matching probability attributes includes displaying icons and summaries using color coordination.

19. The machine-readable medium of claim 13, wherein a brand advertiser may search for an entertainment production based on one or more attributes.

20. The machine-readable medium of claim 13, wherein an entertainment production may search for a brand advertiser based on one or more attributes.
